(19) United States
(12) Patent Application Publication
(10) Pub. No.: US 2015/0032613 A1
(43) Pub. Date: Jan. 29, 2015

(54) PAYMENT SYSTEMS AND METHODS FOR ACCELERATING DEBT PAYOFF AND REDUCING INTEREST EXPENSE

(71) Applicants: Peter C. DiGiulio, Oakhurst, NJ (US); Lynn R. Simmons, Port Washington, NY (US); Jaroslav Kardash, Minsk (BY); Kathy Ann Ventour, Newark, NJ (US); Lauren B. Lazarus, Bayside, NY (US)

(72) Inventors: Peter C. DiGiulio, Oakhurst, NJ (US); Lynn R. Simmons, Port Washington, NY (US); Jaroslav Kardash, Minsk (BY); Kathy Ann Ventour, Newark, NJ (US); Lauren B. Lazarus, Bayside, NY (US)

(21) Appl. No.: 14/451,760

(22) Filed: Aug. 5, 2014

Related U.S. Application Data
(63) Continuation of application No. 13/571,194, filed on Aug. 9, 2012, now abandoned.
(60) Provisional application No. 61/521,740, filed on Aug. 9, 2011.

(51) Int. Cl. G06Q 20/10

(52) U.S. Cl. CPC G06Q 20/102; G06Q 40/025
USPC 705/40

(57) ABSTRACT

The electronic payment systems and methods of the present disclosure accelerate debt payoff and reduce interest expense. A method of operating an electronic payment system includes storing funding source information relating to at least one funding source in a database, storing funding schedule information, which includes funding schedule type, relating to at least one funding schedule corresponding to the at least one funding source in the database, and allocating an available funding amount from the at least one funding source to the plurality of recurring payment accounts based upon the funding source information, the funding schedule information, and the recurring payment account information. A method of enrolling at least one client in an electronic payment system includes receiving client information relating to the at least one client, which includes funding source information relating to at least one funding source and payment account information relating to at least one payment account, selecting a regular funding cycle associated with the at least one funding source, determining a regular funding amount associated with the selected regular funding cycle, determining a plurality of potential funding profiles based upon the client information, and selecting at least one funding profile from the plurality of potential funding profiles.

### CROSS-REFERENCE TO RELATED APPLICATION

This application claims the benefit of and priority to Non-Provisional application Ser. No. 13/571,194, which was filed on Aug. 9, 2012, which claims the benefit of and priority to Provisional Application No. 61/521,740, which was filed on Aug. 9, 2011, the entire contents of each of which are hereby incorporated by reference.

### BACKGROUND

1. Technical Field

The present disclosure relates to payment systems used to reduce debt and satisfy regular payment requirements and, more particularly, to a customizable debt roll-down payment program including an online interface allowing self-enrollment and self-management by a client.

2. Description of Related Art

Debt roll-down payment systems allow debtors to reduce interest expense and increase future wealth by scheduling payments on debt principal. Debt roll-down payment systems typically rank a plurality of debts based upon interest rate. The debtor is scheduled to periodically pay a plurality of debts. The periodic payment remains constant as each debt is paid off. When one debt is paid off, the amount of the periodic payment that had been previously allocated to the paid-off debt is reallocated (i.e., “rolled down”) to the remaining debt with the next highest interest rate. This process can reduce interest expense and debt payment duration.

### SUMMARY

In one aspect, the present disclosure features a method of enrolling at least one client in an electronic payment system. The method includes receiving client information relating to the at least one client. The client information includes funding source information relating to at least one funding source and payment account information relating to at least one payment account. The method further includes selecting a regular funding cycle associated with the at least one funding source, determining a regular funding amount associated with the selected regular funding cycle, determining a plurality of potential funding profiles that adjust the regular funding amount based upon the client information, and selecting at least one funding profile from the plurality of potential funding profiles.

In another aspect, the present disclosure features a computer system for enrolling at least one client in a payment system. The computer system includes a network communications interface configured to receive client information relating to at least one client. The client information includes funding source information relating to at least one funding source, payment account information relating to at least one payment account, a regular funding cycle for the at least one funding source, and a regular funding amount for the at least one funding source.

The computer system further includes a client information database in network communications with the network communications interface. The client information database stores the client information and at least one processor is in network communications with the client information database. The at least one processor is configured to execute a plurality of program instructions, which causes the at least one processor to perform operations including determining a plurality of potential funding profiles based upon the client information and generating a message requesting at least one client to select at least one funding profile from the plurality of potential funding profiles.

In yet another aspect, the present disclosure features a method of operating an electronic payment system. The method includes storing funding source information relating to at least one funding source in a database and storing funding schedule information relating to at least one funding schedule corresponding to the at least one funding source in the database. The funding schedule information includes a funding schedule type. The method further includes storing recurring payment account information relating to a plurality of recurring payment accounts in the database and allocating an available funding amount from at least one funding source to the plurality of recurring payment accounts based upon the funding source information, the funding schedule information, and the recurring payment account information.

Other features of the presently disclosed payment systems and methods will become apparent from the following detailed description, taken in conjunction with the accompanying drawings, which illustrate, by way of example, the presently disclosed electronic payment system.

### BRIEF DESCRIPTION OF THE DRAWINGS

Various embodiments of the present disclosure are described herein with reference to the drawings wherein:

FIG. 1 is a block diagram of a debt payment system in accordance with the present disclosure;

FIG. 2 is a block diagram of the payment system server network of the debt payment system of FIG. 1;

FIG. 3 is a block diagram illustrating cash flow associated with the debt payment system of FIG. 1;

FIG. 4 is a block diagram illustrating debits and payments according to the debt payment system of FIG. 1;

FIG. 5 is a block diagram illustrating timing of debits and payments according to the debt payment system of FIG. 1;

FIG. 6 is a block diagram illustrating re-allocation according to the debt payment system of FIG. 1;

FIGS. 7-8 are charts illustrating operation of the debt payment system of FIG. 1 when there are no excess funds;

FIGS. 9-10 are charts illustrating operation of the debt payment system of FIG. 1 when there are positive excess funds;

FIGS. 11-13 are charts illustrating operation of the debt payment system of FIG. 1 when there are negative excess funds;

FIG. 14 is a diagram of an introduction screen of a graphical client interface for enrolling in and managing a debt payment system in accordance with the present disclosure;

FIG. 15 is a diagram of a future wealth calculator of the graphical client interface of FIG. 14;

FIG. 16 is a diagram of a debt payment system explanation screen of the graphical client interface of FIG. 14;

FIG. 17 is a diagram of a contact information screen of the graphical client interface of FIG. 14;

FIGS. 18A-18C are diagrams of client information screens of the graphical client interface of FIG. 14;

FIG. 19 is a diagram of a contacts summary screen of the graphical client interface of FIG. 14;

FIG. 20 is a diagram of an account information screen of the graphical client interface of FIG. 14;

FIG. 21 is a diagram of an account summary screen of the graphical client interface of FIG. 14;

FIGS. 22A-22B are diagrams of payment schedule creation screens of the graphical client interface of FIG. 14;

FIG. 23A is a diagram of a payment schedule creation screen of the graphical client interface of FIG. 14;

FIG. 23B is a diagram of a suggested first debit payment schedule screen of the graphical client interface of FIG. 14;

FIG. 24 is a diagram of a payment schedule screen with grace period selection of the graphical client interface of FIG. 14;

FIG. 25 is a diagram of a payment reminder screen of the graphical client interface of FIG. 14;

FIG. 26A is a diagram of an additional payment screen of the graphical client interface of FIG. 14;

FIG. 26B is a diagram of a credit card authorization screen of the graphical client interface of FIG. 14;

FIG. 26C is a diagram of a credit card authorization confirmation screen of the graphical client interface of FIG. 14;

FIG. 26D is a diagram of a payment schedule summary screen of the graphical client interface of FIG. 14;

FIG. 27A is a diagram of a future wealth projection screen of the graphical client interface of FIG. 14;

FIG. 27B is a diagram of an authorization screen of the graphical client interface of FIG. 14;

FIG. 27C is a diagram of a enrollment completion screen of the graphical client interface of FIG. 14;

FIG. 28 is a diagram of a membership home screen of the graphical client interface of FIG. 14;

FIG. 29A is a diagram of a contacts manager of the graphical client interface of FIG. 14;

FIG. 29B is a diagram of an accounts manager of the graphical client interface of FIG. 14;

FIG. 29C is a diagram of a payment schedule manager of the graphical client interface of FIG. 14;

FIG. 30 is a diagram of a transactions manager of the graphical client interface of FIG. 14;

FIG. 31 is a diagram of the future wealth projection screen of FIG. 27A; and

FIG. 32 is a diagram of a referral screen of the graphical client interface of FIG. 14.

### DETAILED DESCRIPTION

Particular embodiments of the present disclosure are described below with reference to the accompanying drawings; however, it is to be understood that the disclosed embodiments are merely exemplary of the disclosure and may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

A roll-down payment system is disclosed that provides a client with the ability to schedule funding for making payments to a payee. The term “funding” refers to the movement of funds from a funding source that is owned or controlled by a client. “Funding” or “funds” refers to money that is moved. In particular, funding includes, for example, an ACH debit, a credit card charge, a debit card payment, a wire, or a payment made by the client, e.g., via a personal check. Funding may include debiting any funding source from which funding is successful. Examples of funding sources include accounts held at a financial institution, e.g., savings, checking, and credit accounts. A broker may manage funding on behalf of a client.

The term “payment” refers to a transfer of money to a payee's account, such as for paying a loan or a bill. A client who owes money to a payee is a debtor. A payee is an entity or person to whom a client owes money. A payee account or payment account holds or is configured to hold money transferred to the payee. Examples of payment accounts include a mortgage payment account, a second mortgage payment account, a home equity loan payment account, an automobile loan payment account, an RV loan payment account, a boat loan payment account, a motorcycle loan payment account, a water sports vehicle loan payment account, a student loan payment account, a credit card payment account, a line of credit payment account, a medical payment account, a utility payment account, an expense payment account, and a deferred payment account.

A roll-down payment system may use a variety of funding schedules, typically selected from four different funding schedules: weekly, biweekly, twice-monthly, and monthly. A biweekly roll-down payment system schedules funding every other week. Each funding is half of the total monthly minimum payment of a plurality of payments. There are 52 weeks in each year, resulting in 26 biweekly fundings each year. However, there are only 12 months in each year. Thus, the biweekly funding schedule generates additional funds that amount to two fundings (if the client only had a single loan, this would sum to be one additional payment each year). These additional funds add to the extra funds resulting from roll-down and power plus funding. Power plus funding is an optional additional funding amount (also referred to as a “power payment”) to be taken from each funding account. Any of these additional funds are normally applied to the principal of the debt having the highest interest rate. However, the system provides the client with the flexibility to manually set the order in which to apply extra or additional funds against debt principal. The biweekly roll-down payment system combines the biweekly funding schedule with the debt roll-down payment system to create further interest savings and reduce debt payment duration.

Thus, the payment system according to the present disclosure uses three types of available funds to pay down principal: (1) available funds that are generated by the funding schedule over the course of each year, (2) available funds resulting from rolldown, i.e., when particular debts or expenses are paid off, and (3) available funds from power plus funding.

Although the biweekly roll-down payment system is a powerful tool for helping debtors improve their financial well-being, it is not necessarily optimal for each individual debtor. Also, although some payment systems attempt to improve upon the biweekly roll-down payment system, such systems require consultation with, enrollment by, and management by a financial professional, which increases costs to the debtor.

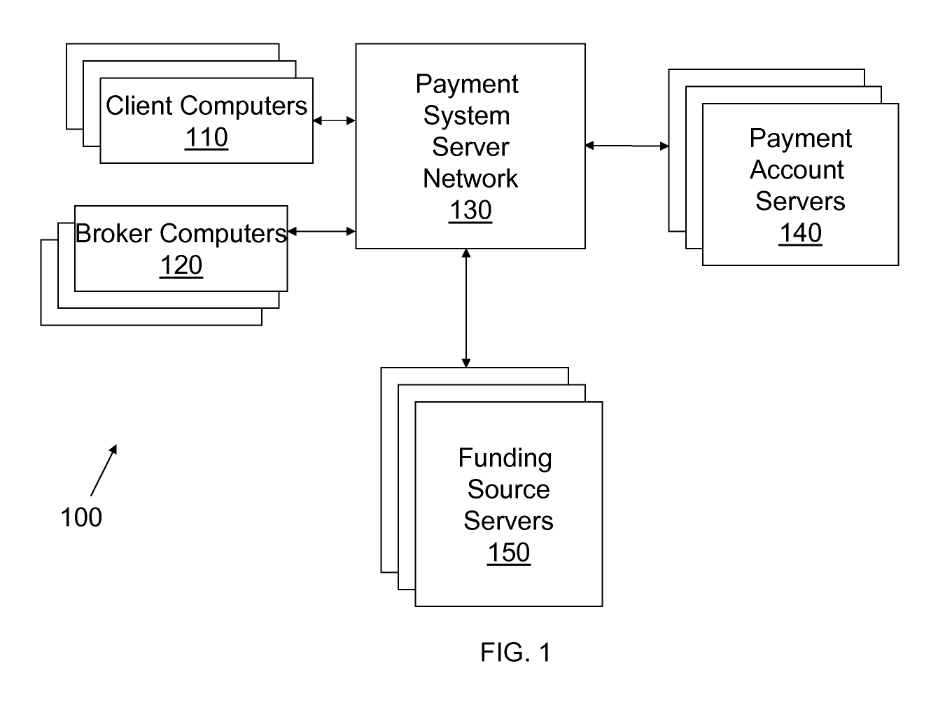

FIG. 1 illustrates a payment system 100 according to an embodiment of the present disclosure. Payment system 100 includes one or more client computers 110, at least one broker computer 120, a payment system server network 130, payment account servers 140, and funding source servers 150. Each of client computers 110, broker computers 120, funding source servers 150, and payment account servers 140 is connected or connectable to payment system server network 130 through the Internet, for example.

Client computers 110 and broker computers 120 may be any type of electronic device, such as a personal computer or a smart phone, capable of accessing payment system server network 130 through the Internet and running a client-side interface for configuring client requirements on the payment system 100. A client may adjust her settings of the payment system 100, or a broker may adjust the client's settings on behalf of the client. It is to be understood that the actions referenced below which can be performed by a client may be performed by the client's broker on behalf of the client. Funding source servers 150 include computers, e.g., servers, of any financial institution designated by the client as a source from which funds are transferred from funding sources by payment system 100. Payment account servers 140 include computers, e.g., servers, associated with any payee account, such as an account associated with an individual, business, or financial institution, designated by the client to which payments are to be made.

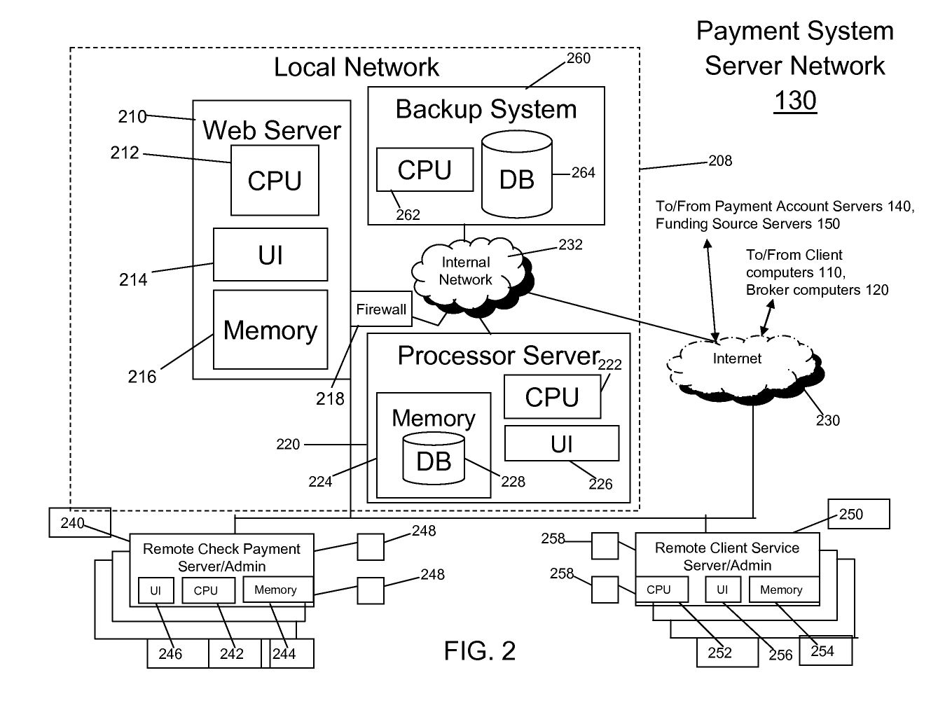

FIG. 2 illustrates payment system server network 130. Payment system server network 130 includes a local network 208, such as a WAN, LAN, WLAN, VLAN, etc., and may further include one or more remote payment servers 240 and/or remote client service servers 250. The local network 208 includes a web server 210, processor server 220, and backup system 260, which are in data communication with an internal network infrastructure 232, including the hardware and software for forming the local network 208. Additionally, web server 210 and processor server 220 are in data communication with an external network, such as the Internet. In an alternate embodiment, the web server 210, processor server 220, and/or backup system 260 may communicate with each other via the Internet and use hardware and/or software to only allow authorized communications with these components.

Web server 210 communicates via the Internet with one or more client computers 110 and broker computers 120 facilitating communication between the payment system server network 130 and the client computers 110 and broker computers 120. In one embodiment, the web server 210 facilitates all of the communication between the payment system server network 130 and the client computers 110 and broker computers 120. The web server 210 may be configured in a variety of ways to facilitate communication between the payment system server network 130 and the client computers 110 and broker computers 120, such as for providing a website having webpages accessible to the client computers 110 and broker computers 120, exchanging emails, and/or exchanging files using a file transfer protocol (FTP).

Web server 210 includes at least one processing device, such as a central processing device (CPU) 212, a firewall 216 including hardware and/or software for providing secure communication, and a user interface 218 via which an administrator can program and/or communicate with the CPU 212. Web server 210 further includes and/or accesses at least one memory device 214, e.g., RAM, ROM, a hard drive, flash memory, etc. A web server software program includes a series of programmable instructions executable by CPU 212 for performing the functions disclosed herein. The web server software program can be stored by memory device 214 or by an external computer-readable medium accessible by the CPU 212, such as a CD-ROM or smart card.

Process server 220 is configured to manage the flow of funds, perform calculations requested by clients, and process the transfer of funds and payments to and from the payment account servers 140 and the funding source servers 150. Process server 220 communicates via the Internet with one or more payment account servers 140, such as by facilitating such communication by providing a website accessible to payment account servers 140, exchanging emails, and/or exchanging files using FTP. In one embodiment, the process server 220 facilitates all of the communication between the payment system server network 130 and the payment account servers 140.

Process server 220 includes at least one processing device, such as a CPU 222 and a user interface 226 through which an administrator can program and/or communicate with the CPU 222. Process server 220 further includes and/or accesses at least one memory device 224, e.g., RAM, ROM, a hard drive, flash memory, etc. The memory device 224 includes a database 228 that stores information related to the clients, client accounts, payees, payee accounts, etc. A process server software program includes a series of programmable instructions executable by CPU 222 for performing the functions disclosed herein. The process server software program can be stored by memory device 214 or by an external computer-readable medium accessible by the CPU 222, such as a CD-ROM or smart card.

Backup system 260 is configured to backup data handled by other components of the payment system server network 130, such as the information stored in database 228. Backup system 260 includes at least one processing device, such as a CPU 262, and a storage device 264 having a database, which may be stored, for example, in one or more of ROM, RAM, a hard drive, or flash memory. Backup system software program includes a series of programmable instructions executable by CPU 262 for performing the functions disclosed herein. The backup system software program can be stored by storage device 264 or by an external computer-readable medium accessible by the CPU 212, such as a CD-ROM or smart card.

The remote payment servers 240 and remote client service servers 250 are configured to access client accounts, such as client checking or saving accounts, e.g., via the funding source servers 150. Each of the remote payment servers 240 and 250 include at least one processing device, such as a CPU 242 or 252, a user interface 246 or 256 via which an administrator or user can program and/or communicate with the CPU 242 or 252. The remote payment servers 240 and remote client service servers 250 further include and/or access at least one memory device 244 or 254, e.g., RAM, ROM, a hard drive, flash memory, etc.

The remote payment servers 240 each include a remote payment server software program having a series of programmable instructions executable by CPU 242 for performing the functions disclosed herein. The remote client service servers 240 each include a remote client service server software program having a series of programmable instructions executable by CPU 252 for performing the functions disclosed herein. The remote payment server software program and the remote client service server program can be stored by respective memory devices 244 and 254 or by an external computer-readable medium accessible by the respective CPUs 242 and 252, such as a CD-ROM or smart card.

An authorized user can operate a workstation 248 that is in data communication with the one of the remote payment servers 240 to prepare and/or print a check that draws funds from a client account. Additionally, the authorized user may operate the workstation 248 to transmit a digital copy of the check to a selected destination or prepare transmission support, such as a mailing label, for transmitting a paper copy of the check to a selected destination. An administrator may operate a workstation 248 or one of the remote payment servers 240 for configuring and managing the remote payment server 240 and managing authorization of users.

An authorized user, such as an administrator or client representative, can operate a workstation 258 that is in data communication with one of the remote client service servers 250 to access a client account 260, such as for accessing balances or transferring funds. The administrator may operate a workstation 258 or one of the remote client service servers 250 for configuring and managing the remote client service server 250 and managing authorization of users to use the workstations 258 and/or access client accounts.

In an alternative embodiment, the remote payment servers 240 and 250 may be included in local network 208, e.g., an intranet, and may be directly connected to internal network 232. Additionally or alternatively, any combination of the components included in the payment system server network 130 may be physically and/or functionally combined or divided.

The web server software program, processor server software program, backup system software program, remote check payment server software program and/or remote client service server software program provide functional and palpable applications in the field of computer technology. The functions of the above software programs may be combined into one or more modules or distributed among a combination of different modules. Any portion of the above described software programs may be downloadable, such as by a smartphone or a personal computer, from a remote source, such as a website (e.g., an “App Store” that sells applications for smartphones).

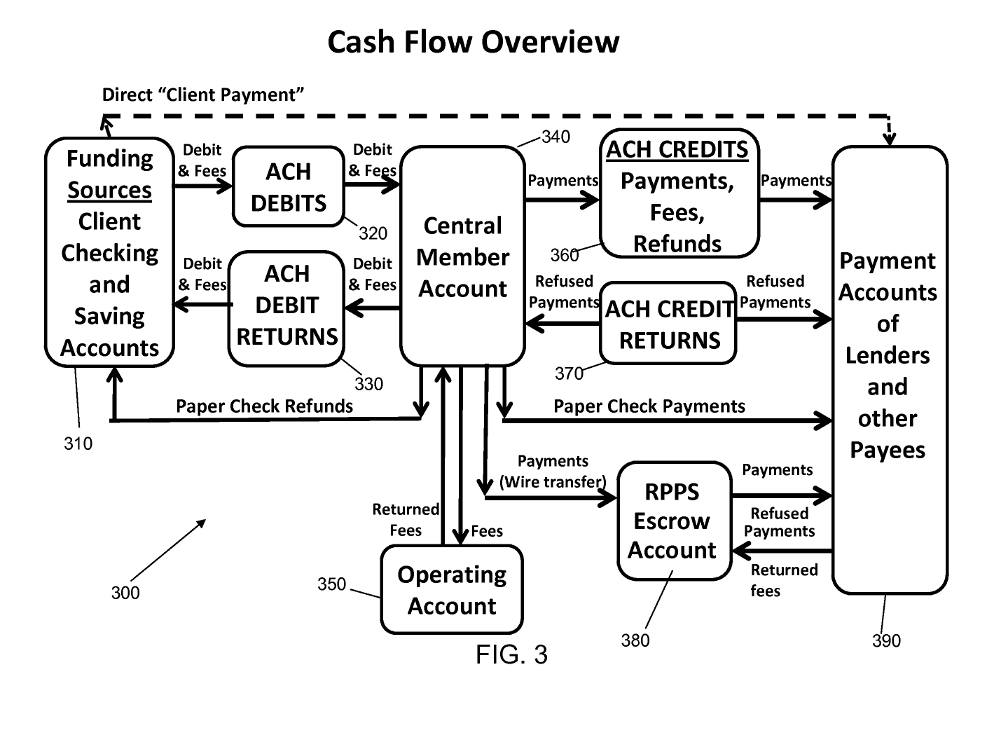

FIG. 3 illustrates cash flow 300 within the payment system 100. Each client has a member account created for the client, as will be described in greater detail below. Central member account 340 contains each of the member accounts. Each member account contains information relating to funding sources 310, such as checking or savings accounts at a financial institution, from which the client wishes to have funds applied to payments. Information stored in central member account 340 allows payment system server network 130 to transfer funds from funding source servers 150 by an electronic funds transfer such as an Automated Clearing House (ACH) debit transfer 320. Funding and fees are thus transferred from the funding sources 310 to central member account 340.

The transferred funds are then paid from central member account 340 to payment accounts 390 of payees, such as lenders, also referred to as payees. Payments may be made by any suitable means. ACH credit transfers 360 are often used. Alternatively, fees could be transferred to an operating account 350. Then funds could be transferred from central member account 340 to a remote payment and presentment service (RPPS) escrow account 380 by wire transfer. Funds are then paid from RPPS escrow account 380 to payees 390. In some cases, the payment need not be electronic. For example, a payment could be made from central member account 340 to the payee 390 via a paper check. Clients may have the option of paying a payee directly, such as by personal check or credit card, which does not require the transfer of funds to member account 340.

Funds may flow in the reverse direction as well. Funding and fees may be returned to the funding sources 310 from a member account when certain events occur, such as a refund, e.g., in the event of member account termination. Funds may be returned from the central member account 340 to a funding source 310 as an ACH debit return 330 or as a paper check refund. Funds may flow from the payees 390 to central member account 340, such as through ACH credit returns 370, in the case of refused payments. Likewise, funds may flow from RPPS escrow account 380 to central member account 340 in the case of refused payments or returned fees.

The cash flow associated with a client is controlled by client requests and/or one or more schedules submitted by the client to the web server 210 executing the web server software program, such as via the website provided by web server 210. The processor server 220 executing the process server software program controls the cash flow. The database 228 is updated in accordance with each transaction. Remote payment servers 240 and 250 may process specific tasks associated with the cash flow.

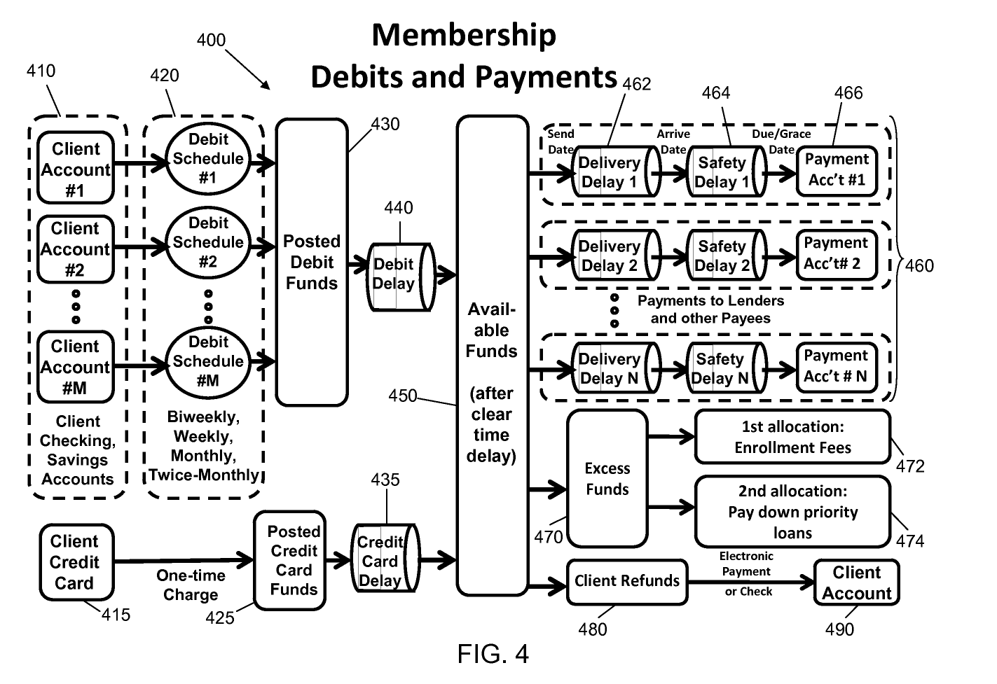

As shown in FIG. 4, reference numeral 400 generally refers to the methods of funding and payment in the payment system 100. Payment system 100 allows a client to have any number M of funding sources, such as client funding accounts 410 (also referred to as client accounts), and any number N of payment accounts 460. A payment account 460 may include any type of loan, debt, or expense accounts associated with a payee, such as a lender. Each of the M client accounts 410 is debited according to a corresponding debit schedule 420 chosen by and managed by the client, as will be described in greater detail below. The debit schedules 420 may include any periodic debits, such as weekly, biweekly, twice-monthly, semimonthly, and monthly. Debit schedules 420 may further include one-time additional funding on top of the periodic funding.

Posted debit funds 430 are posted in accordance with debit schedules 420. There is a debit delay 440, commonly three days, from the posting of posted debit funds 430 and the date when posted debit funds 430 become available funds 450. Available funds 450 are funds available to central member account 340. In addition to the M client accounts 410, a client may place a charge on a credit card 415, for instance, to assist in making an initial funding. After enrolling in payment system 100, a client may also place a charge on credit card 415 to make additional fundings. Credit card funds are posted as credit card funds 425 and become available funds 450 after a credit card delay 435.

Available funds 450 are first allocated to meet the minimum payments of each payment account 466. A delivery delay 462 and a safety delay 464 are scheduled for each payment account 466 to ensure on-time delivery of payments. If there are projected positive excess funds 470, projected positive excess funds 470 are first allocated to enrollment fees 472 for use of the payment system. Once enrollment fees 472 have been paid, projected positive excess funds 470 are allocated to the principal of the highest priority payment account 474, such as a loan having the highest interest rate, a loan having the lowest remaining principal, or a loan having the shortest remaining term.

When one payment account 466 is paid off, optimally the debit schedules 420 are unaffected (although the client may have the discretion to adjust these debit schedules). Thus, the same posted debit funds 430 from the M debit sources 420 are applied to the N−1 remaining payment accounts 460, which guarantees projected positive excess funds 470, assuming no modifications to debit schedules 420 and no failed debits or shortages of funds. Once all N payment accounts 460 are paid off, any remaining funds are refunded to the client as client refunds 480 to a client account 490 that may be the same as a client account 410. Alternatively, a client may have the option to apply remaining funds to expense payments, such as a utility bill payment. A client may also opt to have projected positive excess funds 470 refunded prior to payment accounts 460 being paid off, but it is preferred that the projected positive excess funds 470 be applied to payment accounts 460.

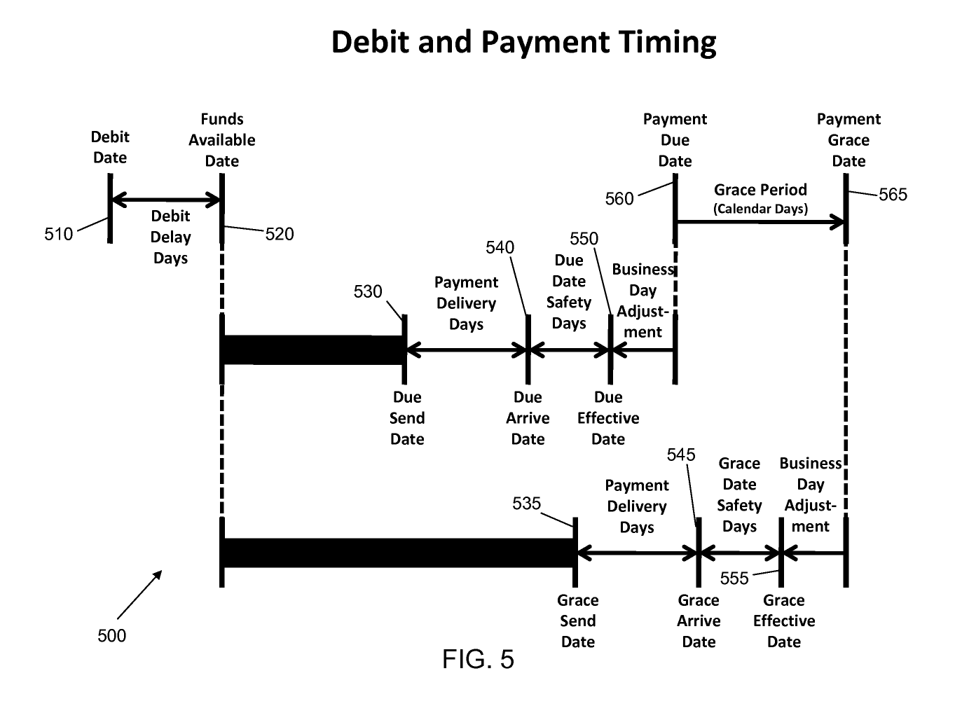

FIG. 5 illustrates the timing of funding debits and payments 500 in the payment system 100. A funding debit is made from a client account 410 on a debit date 510. Debited funds become available to central member account 340 as available funds 450 on a funds available date 520 after debit delay 440, which is typically three days. Once there are sufficient available funds 450 to make a payment to a payment account 466, a payment may be sent. Available funds 450 must be sufficient for a payment by a due send date 530 to ensure payment by a payment due date 560. After due send date 530, a due arrive date 540 accounts for payment delivery days, a due effective date 550 accounts for due date safety days, and a business day adjustment accounts for non-business days to provide a sufficient buffer between due send date 530 and payment due date 560 to ensure on-time payment.

If a client chooses to use grace days for a payment, the payment must be fully funded by a grace send date 535 after due send date 530. After grace send date 535, a grace arrive date 545 accounts for payment delivery days, a grace effective date 555 accounts for grace date safety days, and a business day adjustment accounts for non-business days to provide a sufficient buffer between grace send date 535 and payment grace date 565 to ensure on-time payment.

The number of business day adjustment days is the number of days between payment due date or payment grace date and the latest business day before the payment due date or payment grace date, respectively. The number of payment delivery days varies with the payment delivery method. For instance, two days are commonly used for a paper check payment that is sent with second day special delivery. The number of due date safety days is typically one day if there is a grace period and two days if there is no grace period. The number of grace date safety days is typically two days. Thus, the number of due date safety days is equal to the number of grace date safety days when there is no grace period. This provides greater assurance that a payment will not be late.

In embodiments, the payment system may include a graphical client interface that allows a client to apply the grace period to selected payments and/or selected payment accounts to which payments are applied. For example, the graphical client interface may allow a client to apply the grace period to all payments for a particular loan.

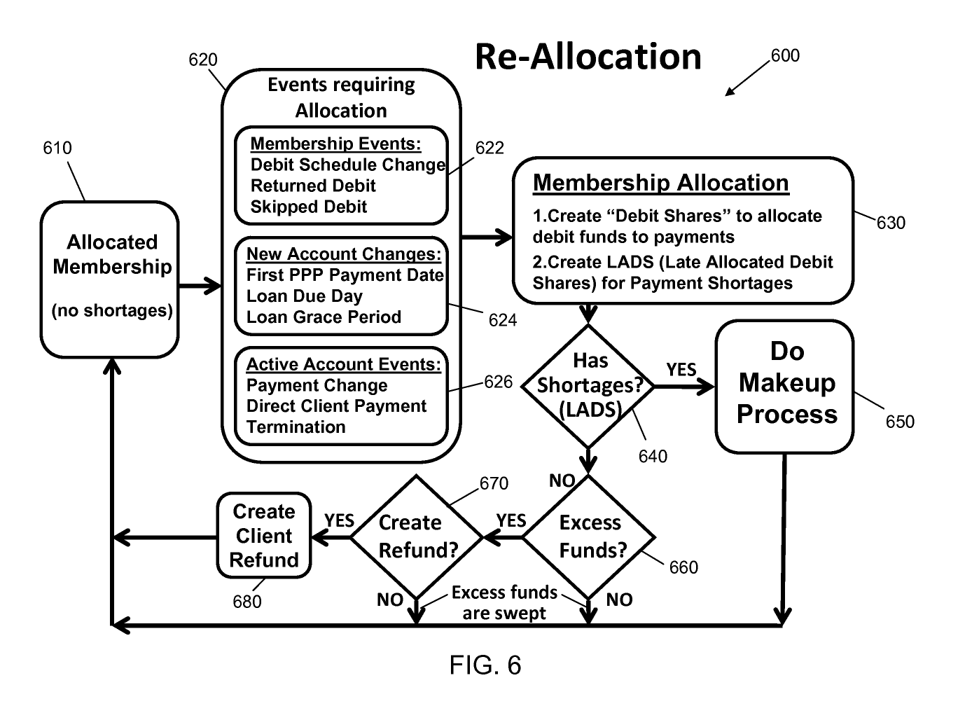

FIG. 6 illustrates re-allocation of funds 600, which is performed by the payment system 100. The cycle begins or continues at step 610 without the existence of shortages or excess funds. Thus, re-allocation is not needed. Three basic types of events 620 require allocation or re-allocation of funds: membership events 622, new account changes 624, and active account events 626. Membership events 622 include debit schedule changes and other funding schedule changes, returned debits due to insufficient funds, and skipped debits. New account changes 624 include setting the first payment date, setting the payment account due dates, and setting the payment account grace periods. Active account events 626 include payment changes, direct client payments, and termination of the account including termination other than payoff.

When a re-allocation event 620 occurs, membership allocation 630 is initiated. Funds are re-allocated to funding shares for paying each payment account 466. If there are projected positive excess funds 470 determined at step 660, it is determined at step 670 whether or not a refund should be created. If it is determined that a refund should be created, a client refund 480 is created at step 680; otherwise, the excess funds are allocated to payment accounts 460, i.e., the excess funds are “swept” across payment accounts 460.

In the case of a projected shortage of funds 640, or negative excess funds, such that a full payment cannot be made to a payment account 466, a late allocated debit share (LADS) is created. A makeup process 650 is then initiated. The client has the option of scheduling a new debit for each LADS or one or more debits that together are to be allocated to the LADS. Alternatively, the client could opt to make a direct payment to the payment account 466. The cycle continues at step 610 after re-allocations have been made for determined shortages or excesses.

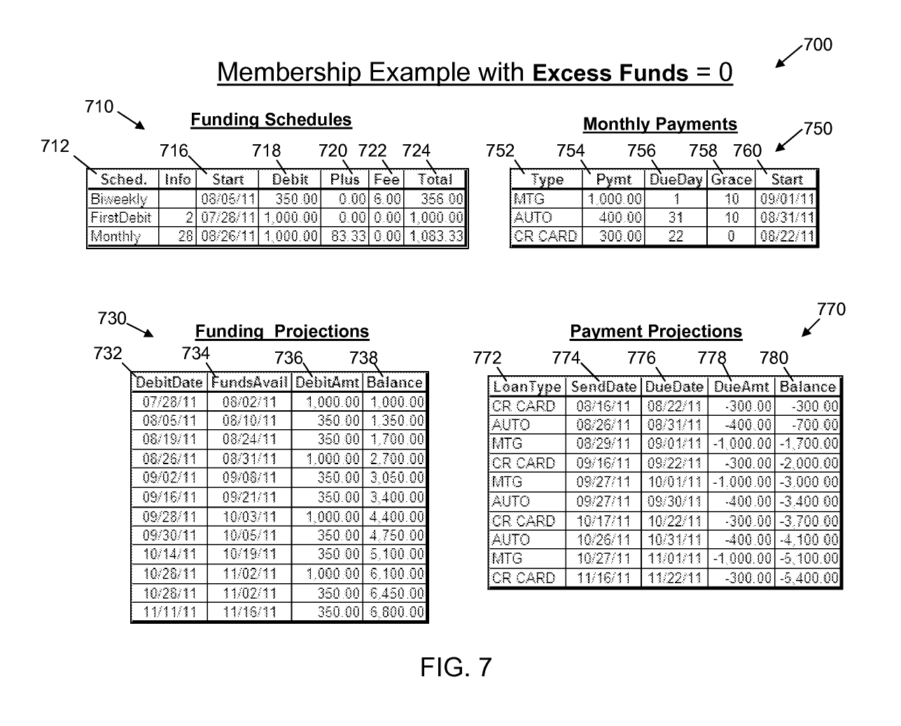

FIGS. 7-13 illustrate examples of the payment system 100 allocating funds. FIG. 7 illustrates allocation of funds having no projected excesses or shortages 700. A funding schedule 710 includes a period 712, a start date 716, a funding debit amount 718, an additional funding referred to as “plus” 720, a fee 722, and a total funding amount 724. A payment schedule 750 includes a payment type 752, a payment amount 754, a due day 756, a grace period 758, and a start date 760.

Funding projections 730 and payment projections 770 are projected for a predetermined time frame, such as three months, based on funding schedule 710 and payment schedule 750, respectively. Funding projections 730 include funding debit dates 732, funds available dates 734, funding debit amounts 736, and balances 738. Payment projections 770 includes payment types, referred as loan types 772, send dates 774, due dates 776, due amounts 778, and balances 780.

Balances 738 are projected by cumulatively summing funding amounts 736 for the various funds available dates according to funding schedule 710. Similarly, balances 780 are projected by cumulatively summing due amounts 778 for the various send dates 774 according to payment schedule 750. A grace period is not taken into consideration in this scenario.

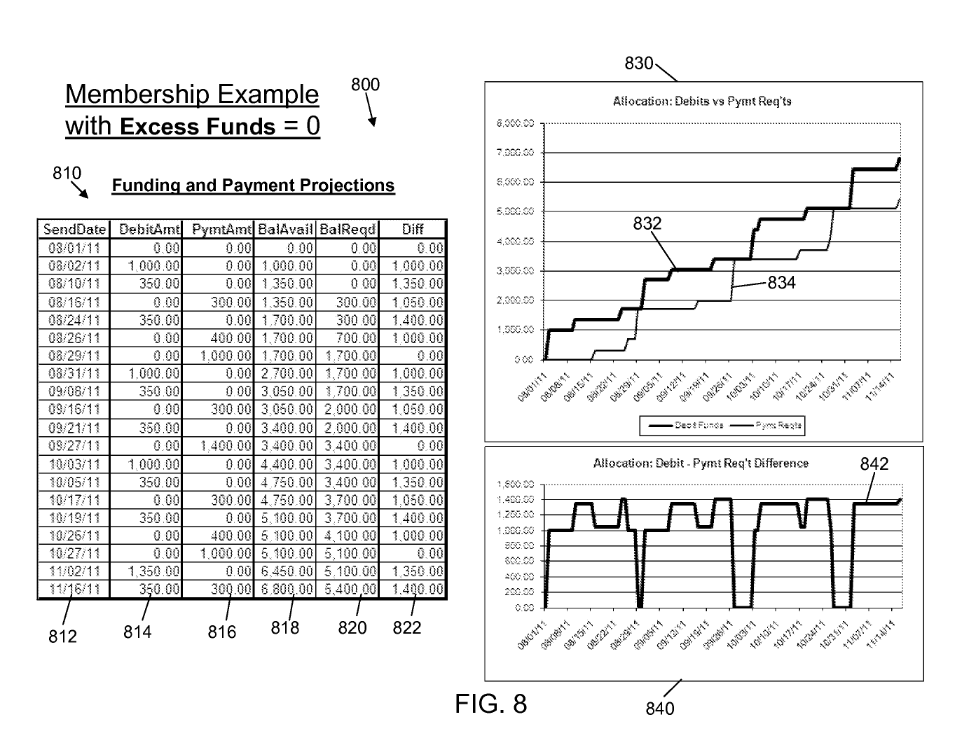

FIG. 8 shows tables and graphs 800 created from funding projections 730 and payment projections 770. Funding and payment projections 810 are defined by send dates 812, funding debit amounts 814, payment amounts 816, available balances 818, required balances 820, and differences 822. The send dates 812 are when available funds (having an available funds date 734) are used to initiate a payment (having a payment send date 774).

Available balances 818 are sums of all funding amounts 814 up to a corresponding send date 812. Required balances 820 are sums of all payment amounts 816 up to a corresponding send date 812. Each difference 822 is the value of a required balance 820 subtracted from an available balance 818 for a send date 812. Differences 822 are searched for a lowest difference. In this example, the lowest difference among the differences 822 is zero, which indicates that there are no projected positive excess funds 470, nor is there a projected shortage of funds 640. Thus, there are no excess funds to automatically move or “sweep” to a different payment account, nor are there shortages to makeup.

Cumulative graph 830 and difference graph 840 visually depict differences 822. Cumulative graph 830 includes an available balances line 832 and a required balances line 834. Available balances line 832 shows available balances 818 for all dates during the predetermined time frame, and required balances line 834 shows required balances 820 for all dates during the predetermined time frame. Differences 822 are visually represented by the distance between available balances line 832 and required balances line 834. Subtracting required balances line 834 from available balances line 832 yields a difference line 842 in a difference graph 840. Difference line 842 represents differences 822 for all dates during the predetermined time frame. Difference line 842 is examined for minimum values. As shown in difference graph 840, difference line 842 has recurring minimum values of zero, which indicates that there are no projected positive excess funds 470, nor is there a projected shortage of funds 640. Thus, there are no excess funds to sweep, nor are there shortages to makeup.

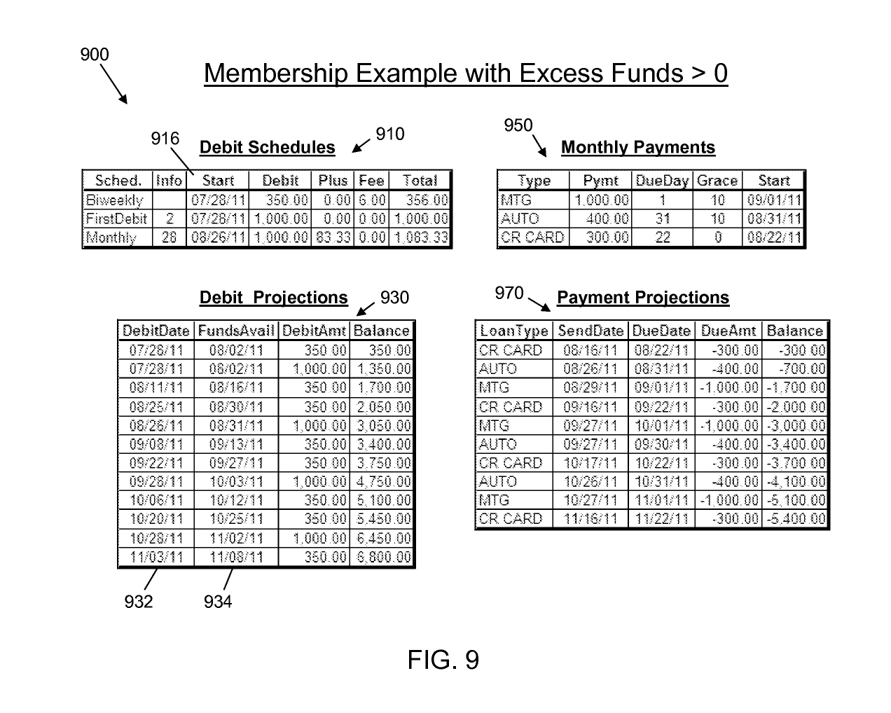

FIG. 9 illustrates allocation of funds 900 having positive projected excess funds 470. Payment schedule 950 and payment projections 970 are identical to payment schedule 750 and payment projections 770, respectively. Funding schedule 910 is identical to funding schedule 710, except a start date 916 is earlier than a corresponding start date 716. Funding projections 930 are identical to funding projections 730, except that some funding dates 932 and funds available dates 934 are earlier than corresponding funding dates 732 and funds available dates 734. A grace period is not taken into consideration in this scenario.

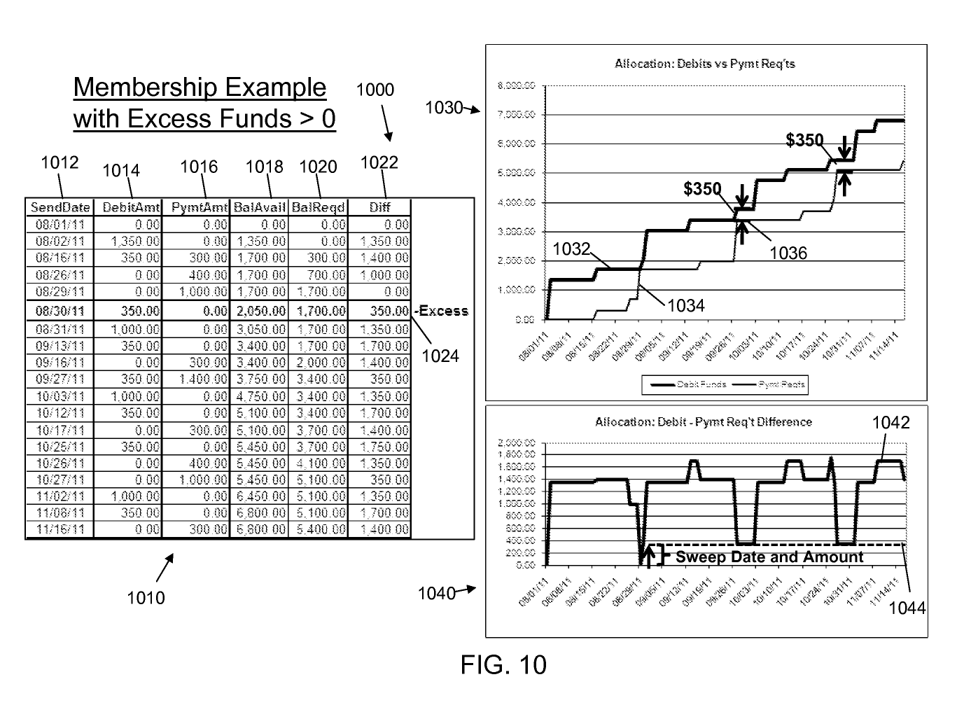

FIG. 10 shows tables and graphs 1000 created from funding projections 930 and payment projections 970. Funding and payment projections 1010 are similar to funding and payment projections 810 and include send dates 1012, funding amounts 1014, payment amounts 1016, available balances 1018, required balances 1020, and differences 1022. Due to the start date 916 being earlier than the corresponding start date 716, a positive minimum difference 1024 of $350 begins on Aug. 30, 2011. Thus, $350 can be applied to payments on Aug. 30, 2011 without creating a projected shortage of funds. A cumulative graph 1030 and a difference graph 1040 illustrate the positive minimum difference 1024. Cumulative graph 1030 includes an available balances line 1032 and a required balances line 1034. After Aug. 29, 2011, there is always a gap 1036 of at least $350 between available balances line 1032 and required balances line 1034. Likewise, difference graph 1040 has a difference line 1042 that never falls below a minimum threshold 1044 of $350 beyond Aug. 29, 2011, thereby showing a positive minimum difference 1024.

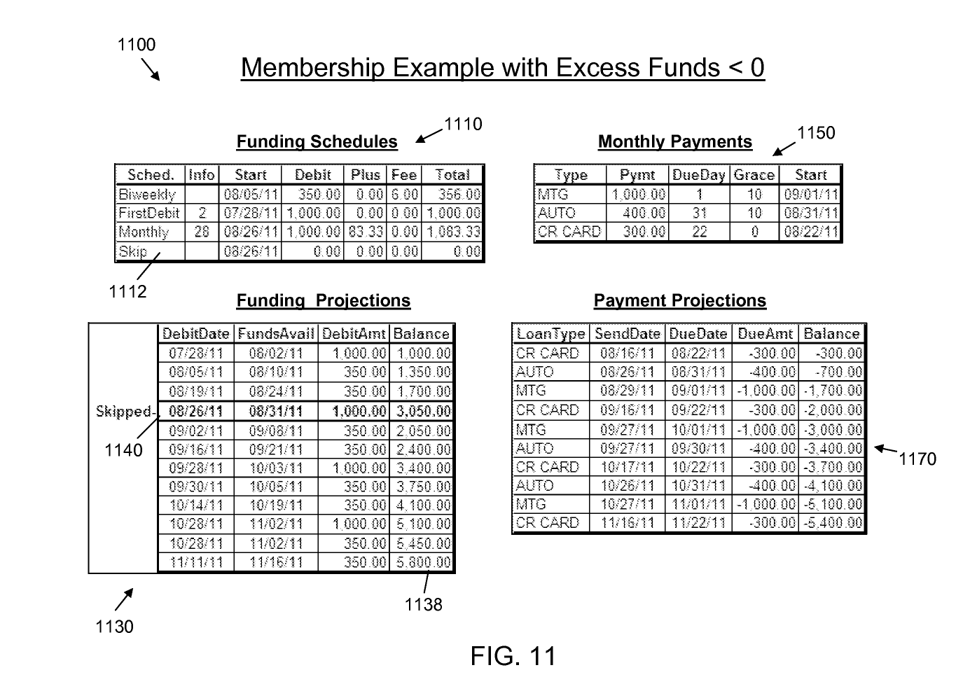

FIG. 11 illustrates allocation of funds 1100 having a projected shortage of funds 640. Payment schedule 1150 and payment projections 1170 are identical to payment schedule 750 and payment projections 770, respectively. A funding schedule 1110 is identical to funding schedule 710 except for a skipped funding 1112 of $1000. Funding projections 1130 are identical to funding projections 730 except that every balance 1138 after a projected skip 1140 projected from skipped funding 1112 is $1000 less than a corresponding balance 738. A grace period is not taken into consideration in this scenario.

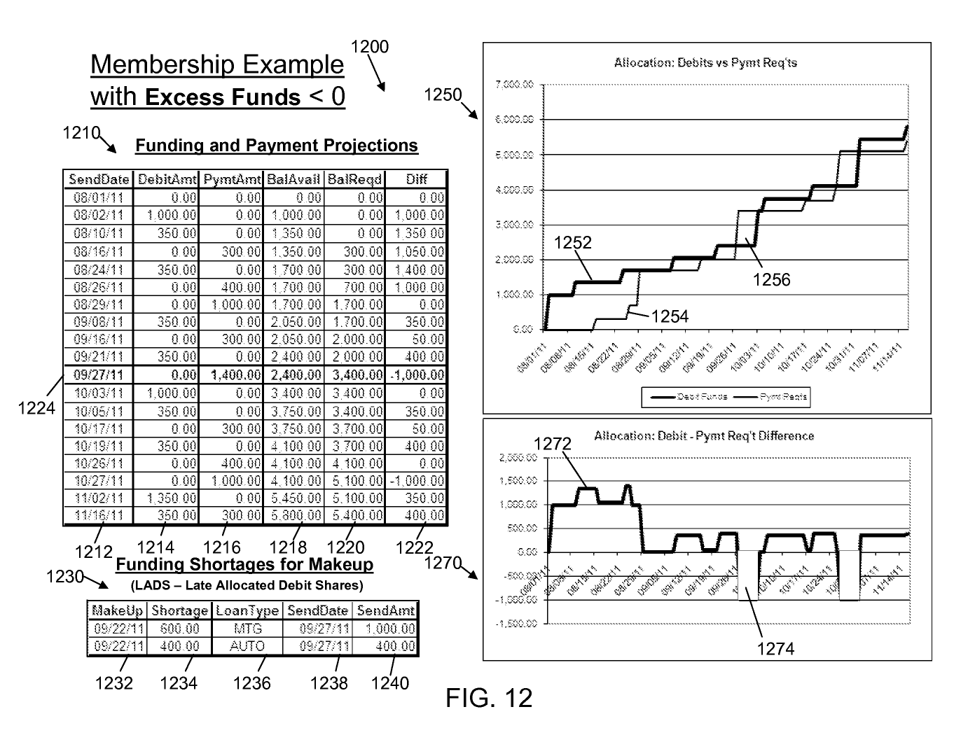

FIG. 12 shows tables and graphs 1200 created from funding projections 1130 and payment projections 1170. Funding and payment projections 1210 are similar to funding and payment projections 810 and include send dates 1212, funding amounts 1214, payment amounts 1216, available balances 1218, required balances 1220, and differences 1222. Due to the skipped funding 1112 on Aug. 26, 2011, a projected shortage of funds 1224 is projected to occur on Sep. 27, 2011. A makeup funding must be scheduled early enough so that sufficient funds are available by Sep. 27, 2011 to eliminate the $1000 total shortage between the “MTG” and “AUTO” payments. Consequently, makeup fundings 1230 totaling $1000 are scheduled on Sep. 22, 2011 to prevent projected shortage of funds 1224 from occurring. A cumulative graph 1250 and a difference graph 1270 illustrate the projected shortage of funds 1224 without the makeup fundings. Cumulative graph 1250 includes an available balances line 1252 and a required balances line 1254. From Sep. 27, 2011 to Oct. 4, 2011, available balances line 1252 is below required balances line 1254. Likewise, difference graph 1270 has a difference line 1272 that falls below zero in shortage areas 1274, thereby showing projected shortage of funds 1224.

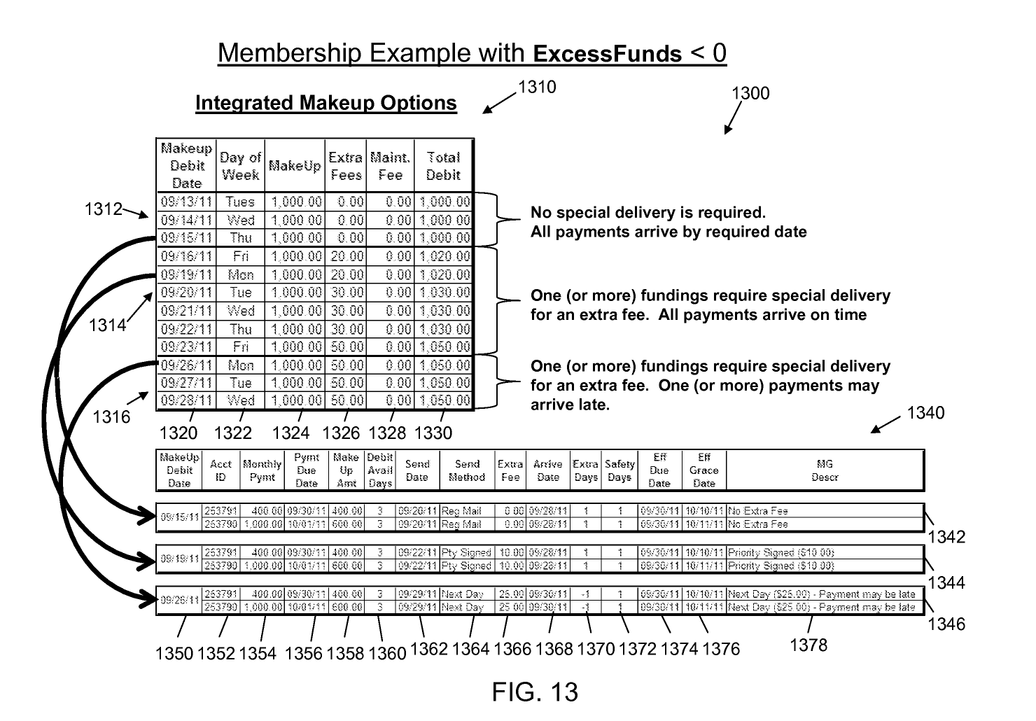

FIG. 13 illustrates integrated makeup options 1300. A table of makeup options 1310 includes makeup funding dates 1320, makeup amounts 1324, extra fees 1326, and total funds 1330. Early makeup fundings 1312 do not require special delivery and thus require zero extra fees 1326. Special makeup fundings 1314 require special delivery to ensure on-time arrival and thus require extra fees 1326. Late makeup fundings 1316 require special delivery and are not guaranteed to arrive on time. Late makeup fundings 1316 have the highest extra fees 1326 for quickest delivery.

Alternatively, the client may pay one or both of the “MTG” and “AUTO” payments directly to payees to eliminate the projected shortage of funds 1224. For example, the client could elect to directly make only the $1000 MTG payment (which was short by $600), thereby freeing up $400 (which was allocated towards the MTG payment). This would cover the $400 shortage in the AUTO payment. Once the client informs the payment system 100 that they would make the direct $1000 MTG payment, the allocation process would reallocate the freed up $400 MTG funds for use to cover the $400 AUTO payment shortage, thereby removing its LADS transaction.

Makeup funding execution table 1340 shows information about three particular makeup debits 1342, 1344, 1346, made on makeup debit dates 1350, specifically, Sep. 15, 2011, Sep. 19, 2011, and Sep. 26, 2011, respectively. A makeup debit (which may also be referred to as a makeup funding) may be a one-time funding. The information includes: the funding account ID 1352; the required monthly debit 1354; the payment due date 1356; the makeup debit amount 1358; the debit funding available days 1360, i.e., the number of days until the makeup debit becomes available; the send date 1362, i.e., the date the available funds from the makeup debit was sent; the send method 1364, i.e., the method by which the available funds from the makeup debit was sent,; the extra fee 1366 charged for using the send method 1364; the expected arrival date 1368 of the makeup debit funds; the, extra days 1370, i.e., the number of days that the expected arrival date exceeds the payment due date; the number of safety days 1372; the effective payment due date 1374; the effective grace date 1376; and the descriptions 1378 that describe the status of the payment, such as what fees were incurred and whether the payment is expected to be on time.

The funds from the first makeup debit 1342 were sent early enough to avoid incurring an extra fee, and its expected arrival date 1368 is before the effective due date 1374. The funds from the second makeup debit 1344 were sent early enough to arrive before the effective due date 1374; however, the send method 1364 was priority mail and incurred a $10.00 fee. The funds from the third makeup debit 1346 were sent by special delivery to arrive the next day, incurring a $25.00 fee; however, the expected arrival date 1368 is the same as the effective due date 1374, and, as such, there is no guarantee that the funds from the makeup debit will be posted on time.

Funding debit amounts that are available for allocation may be allocated amongst a plurality of payment accounts based on the order of the dates by which payments need to arrive without being late. Allocation of the available debit amounts thus may be determined based on factors such as the effective due date 1374 of each payment account (or, alternatively, the effect grace date 1376), the number of days it takes to deliver the payment based on the send method 1364, and payment safety days 1372. The funding amount that is available is determined based upon factors such as a funding availability period, during which funds are available to be drawn from the funding source. The funding availability period may be determined based upon factors such as the type of the funding source, which may include checking accounts, savings accounts, and credit accounts. For example, the funding availability period of an ACH debit from a checking account is three business days and the funding availability period for payment via a credit card account is 2 business days.

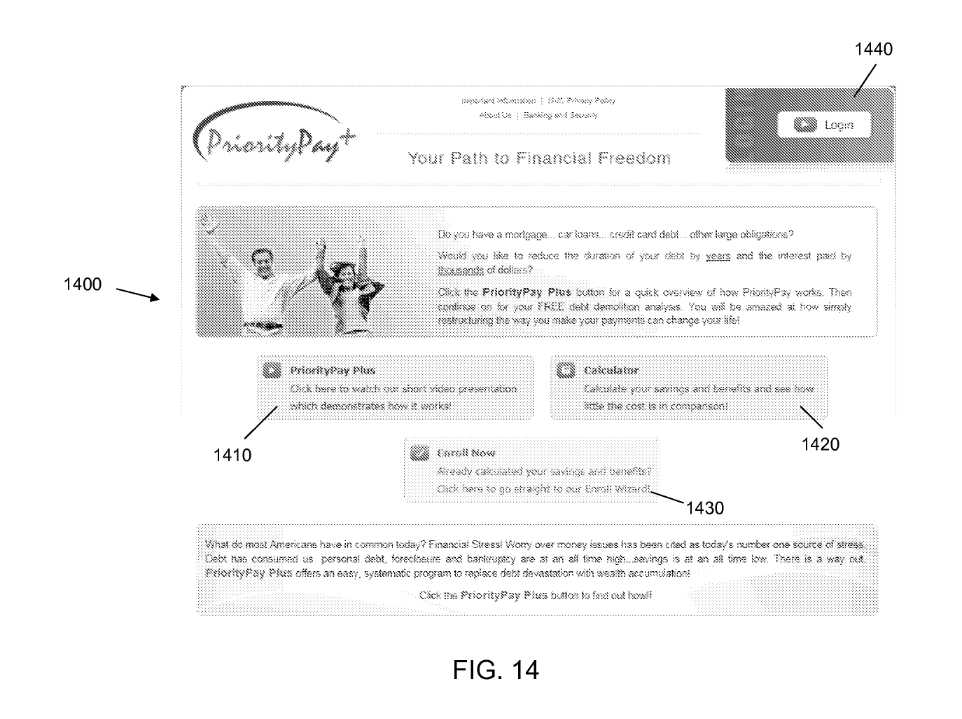

FIGS. 14-32 illustrate an enrollment and management method and system in accordance with the present disclosure. The enrollment and management system may be used by any client from client computers 110 or by a broker on behalf of a client from broker computers 120. As used herein, the term “funding” generally refers to using a client's funds to pay a debt or expense. For example, the term “funding” may refer to moving currency from a client account to a lender's account. From the perspective of the client, funding may be referred to as a payment. Accordingly, the web pages shown in FIGS. 14-32 can use the term “payment” to refer to funding. As used herein, the term funding may refer to a debit or an extra or additional payment which is applied against principal, i.e., a “power plus” funding.

As shown in FIG. 14, by accessing a start web page 1400 provided by web server 210, a client may click on a presentation link 1410 to learn about payment system 100, such as through a video presentation. The client may click a calculator link 1420 to calculate potential savings and benefits based on payment information. The client clicks an enrollment link 1430 to enroll in payment system 100. A client who has already enrolled may login from the login link 1440 to manage his member account.

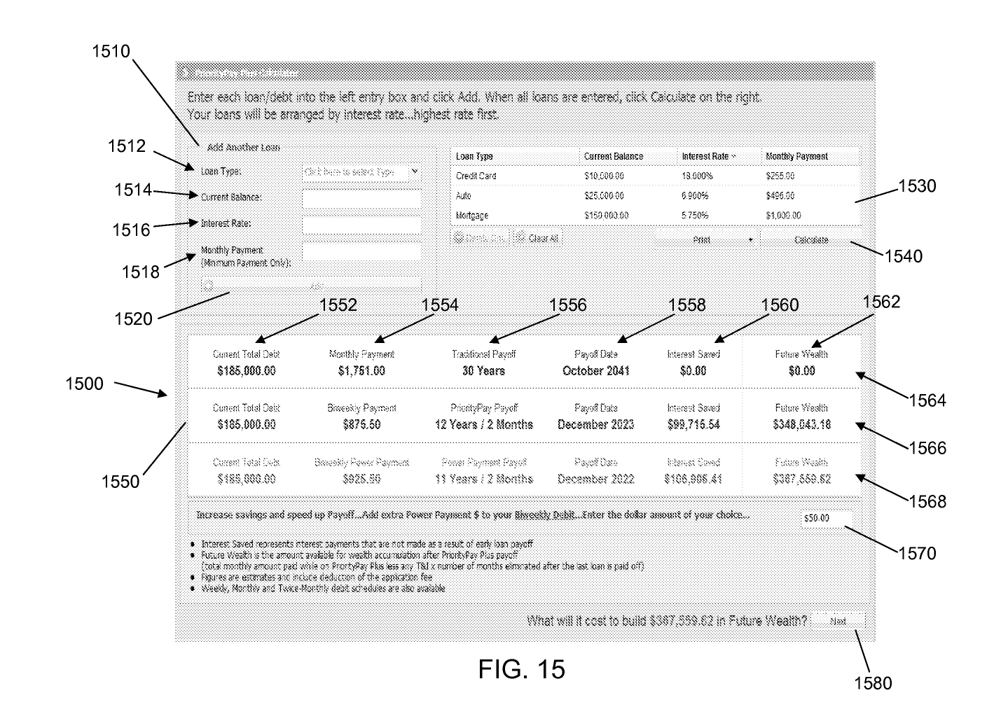

Clicking on calculator link 1420 takes the client to a calculator web page 1500 shown in FIG. 15. In the current example, the payment is for a loan. The client may enter loan payment information into loan payment information input boxes 1510. Loan payment information boxes 1510 include a loan payment type input box 1512, a current balance input box 1514, an interest rate input box 1516, and a monthly minimum payment input box 1518. When loan payment information for a particular payment is entered into loan payment information boxes 1510, clicking an add button 1520 adds the loan payment information to a loan payment information table 1530 and clears loan payment information input boxes 1510 for inputting loan payment information regarding another payment. An optional additional loan payment may be input via additional loan payment input box 1570.

When all loan payment information is added to loan payment information table 1530, clicking a calculate button 1540 calculates and displays projections in a projections table 1550. Projections table 1550 includes a current debt column 1552, a payments column 1554, a payoff length column 1556, a payoff date column 1558, an interest saved column 1560, and a future wealth column 1562. Projections table 1550 further includes a traditional payoff row 1564, a biweekly payment row 1566, and a biweekly power payment (also referred to as a power plus funding) row 1568. Current debt column 1552 sums all values provided in current balance input box 1514 and displays the sum in each row of current debt column 1552. Monthly payments column 1554 displays the sum of the monthly minimum payments inputted into monthly minimum payments input box 1518 in traditional payoff row 1564.

Some clients desire to pay more than the monthly minimum payment on a loan, e.g., a balance on a credit card. Often these clients desire to pay a round number. Thus, in embodiments, the monthly minimum payments input box 1518 allows a client to input a minimum payment for a loan that is greater than the minimum payment required by the lender. For example, a client may wish to pay a minimum of $100 on a credit card even though the minimum payment required by the credit card company is $57. The computation of the benefits and savings described herein may take into account this additional payment that exceeds the required minimum payment.

Half of the sum of the monthly minimum payments is displayed in biweekly funding row 1566. Half of the sum of the monthly minimum payments plus the value input into additional funding input box 1570 is displayed in biweekly power funding row 1568. Payoff length column 1556 displays a projected payoff length for each row. Payoff date column 1558 displays a projected payoff date for each row. Interest saved column 1560 displays a projected interest saved amount for each row, with the value for traditional payoff row 1564 being zero. Future wealth column 1562 displays a projected future wealth amount for each row, with the value for traditional payoff row 1564 being zero. Future wealth amounts are equal to the total minimum monthly payments multiplied by the difference between the payoff length of traditional payoff row 1556 and the payoff length of the row for which the future wealth amount is being calculated. At any time the client may click next button 1580 to leave calculator page 1500.

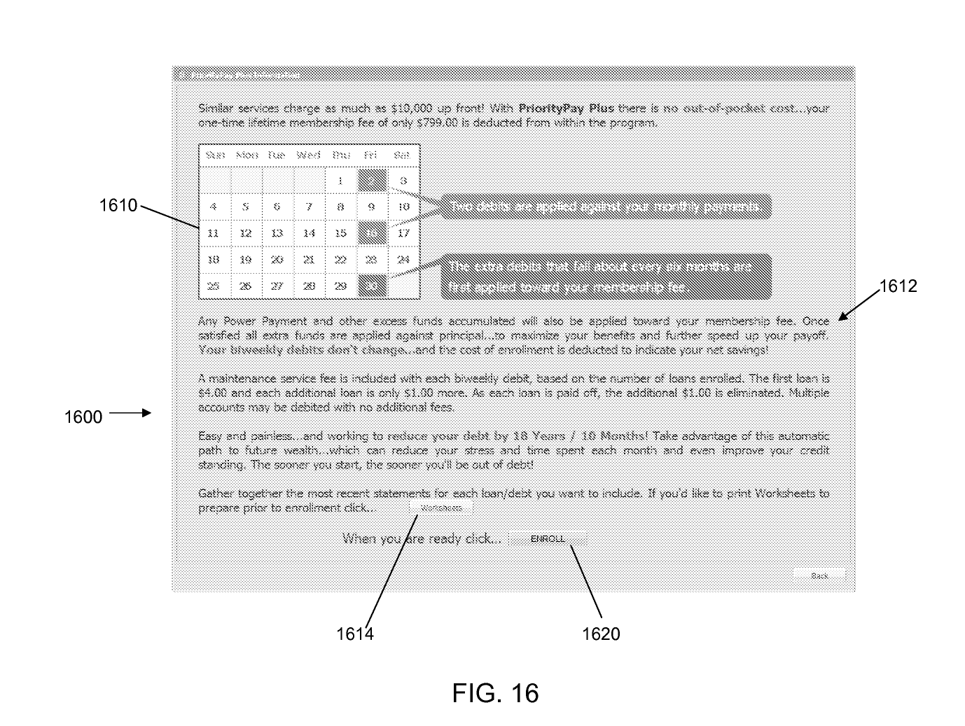

In operation, the data input at page 1500 is received by the web server 210 of FIG. 2, which executes the web server software program, and provides the date to the processor server 220. The processor server 220 executing the process server software program retrieves data associated with the client, such as the client's current total debt shown in column 1552, generates calculated values and provides the calculated values to the web server 210 for display on the web page 1500, such as at payoff length column 1556, payoff date column 1558, interest saved column 1560, and future wealth column 1562. Likewise, the web server 210 generates the pages shown in FIGS. 16-32, and provides client-entered data to the processor server 220 and requests the processor server 220 to process the client-entered data. Results of the processing are provided by the processor server 220 to the web server 210, which communicates the results to the client by displaying them via a web page.

FIG. 16 illustrates an information page 1600. Information page 1600 may be accessed by clicking next button 1580. Information screen 1600 has an exemplary calendar 1610 and accompanying text 1612 describing how the payment system 100 generally works, costs associated with enrolling in the payment system 100, and how the costs are calculated. Clicking a worksheet link 1614 provides worksheets that help the client organize information for proceeding with the enrollment process. The client clicks enrollment button 1620 when the client is ready to begin entering enrollment information.

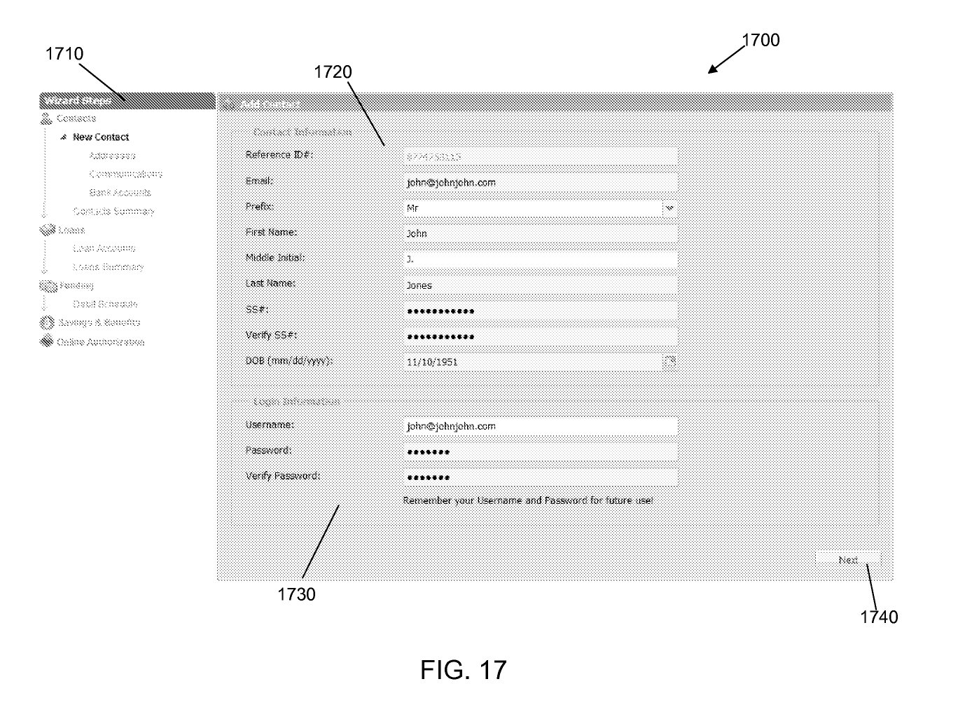

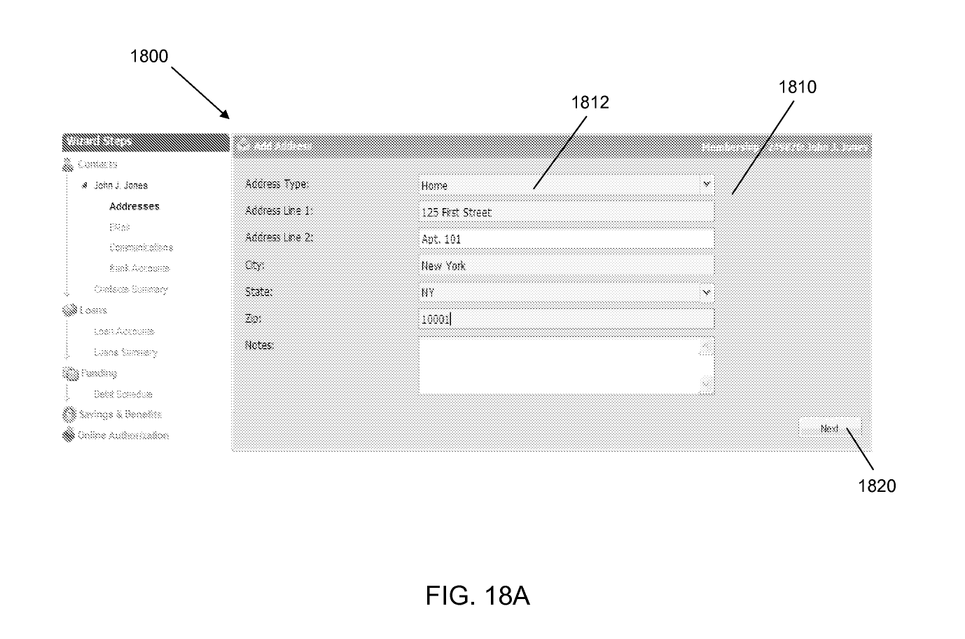

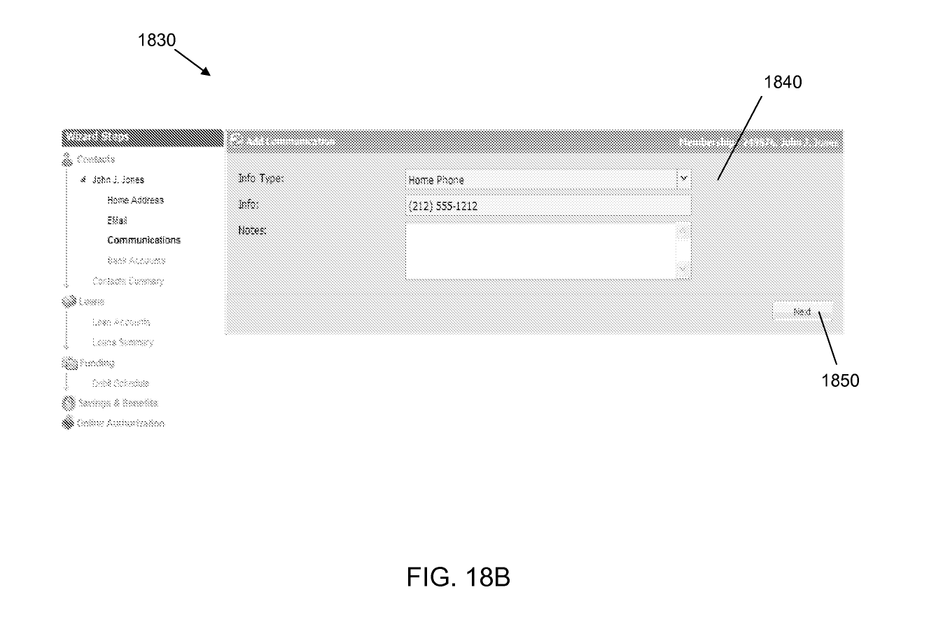

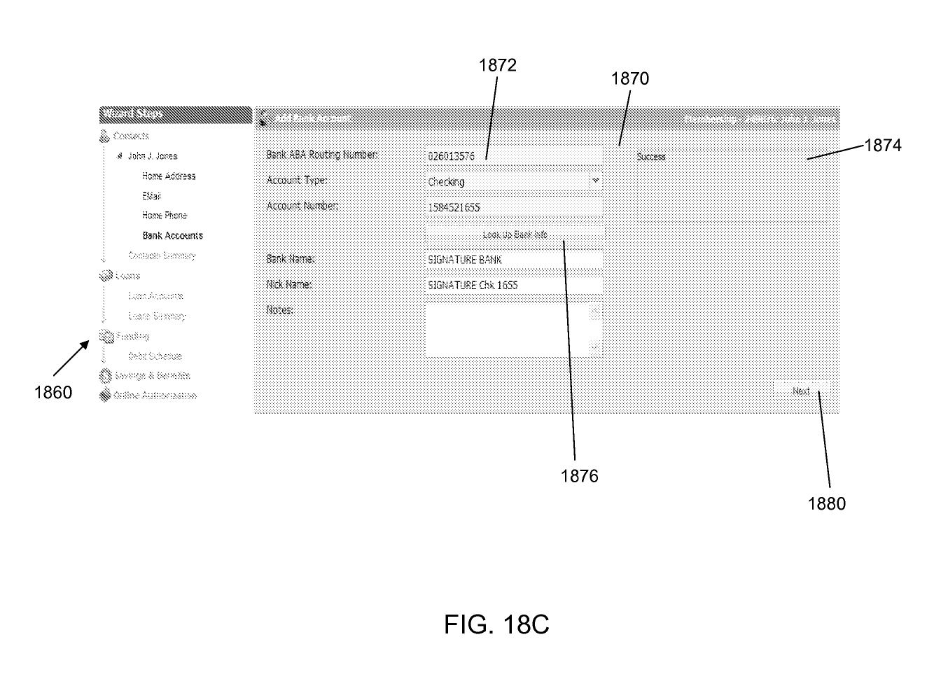

A contact information screen 1700 is shown in FIG. 17. Contact information screen 1700 includes a wizard sidebar 1710 displaying a current step of the enrollment process. The client enters information such as email address, name, social security number, and date of birth, into contact fields 1720. Login fields 1730 allow clients to enter their email address as their username and allow the client to choose a password for account management. Clicking next button 1740 takes the client to an address input screen 1800 shown in FIG. 18A.

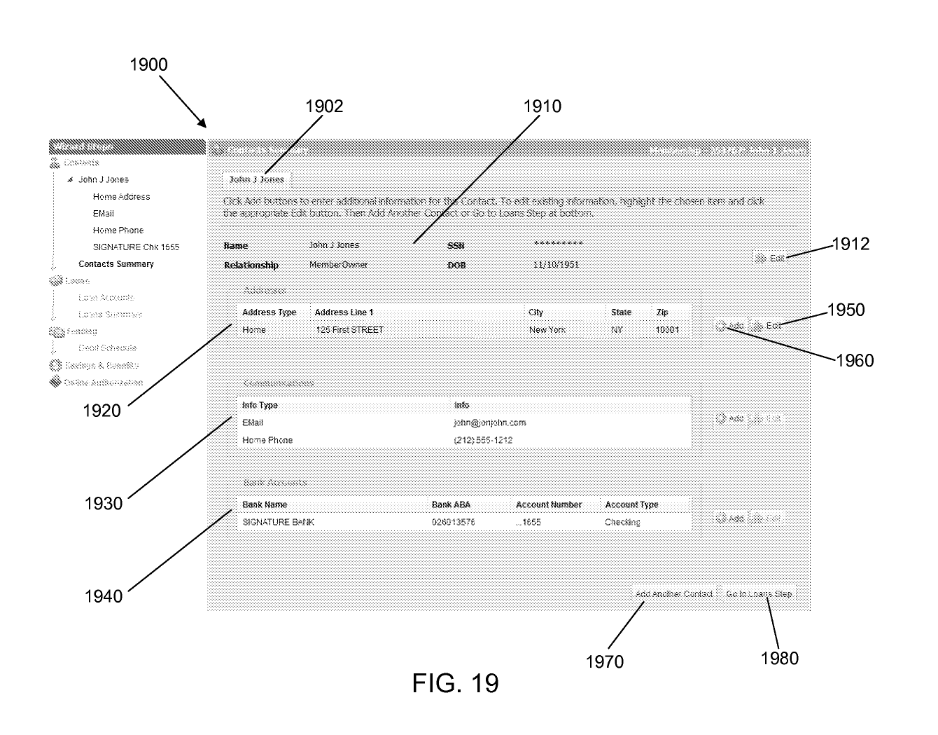

As shown in FIG. 18A, address input screen 1800 provides address fields 1810 in which the client enters address information. An address can be entered for more than one address type selected via a drop down menu in address type field 1812. Clicking next button 1820 takes the client to a communication input screen 1830, as shown in FIG. 18B, in which the client enters communication information, such as a phone number, into communication fields 1840. Clicking next button 1850 takes the client to a funding account input screen 1860, as shown in FIG. 18C, in which the client enters funding account information, such as checking and savings account information, into funding account fields 1870. A routing number entered into a routing number field 1872 is automatically validated upon entry of the routing number, the results of which are displayed in routing number validation box 1874. A bank query button 1876 may be activated for looking up bank information. Clicking next button 1880 takes the client to a contacts summary screen 1900 shown in FIG. 19.

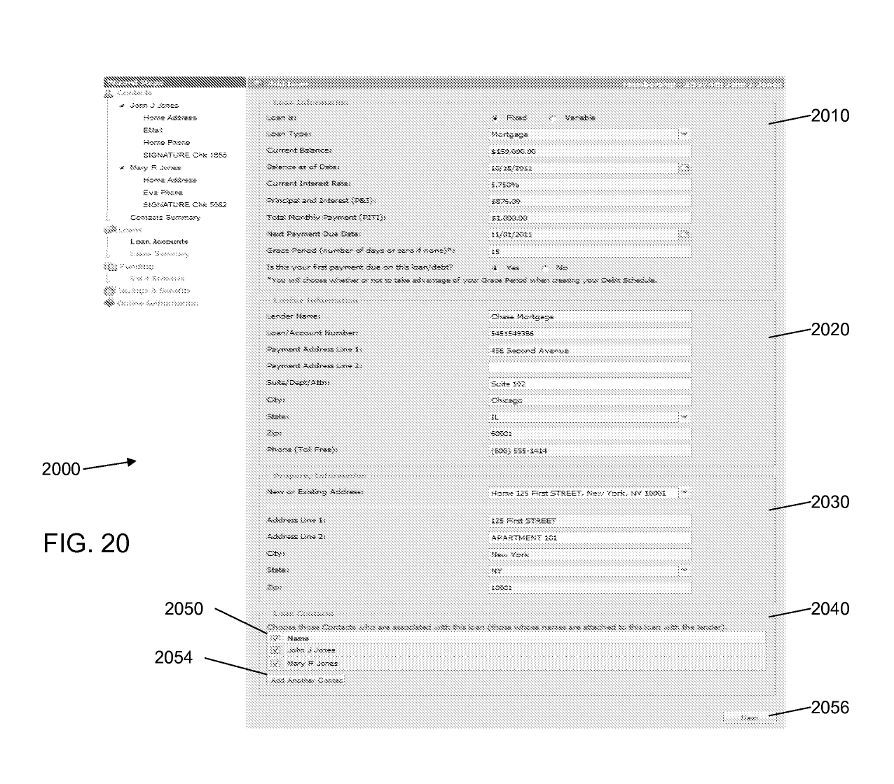

As shown in FIGS. 18A, 18B, and 19, contacts summary screen 1900 shows information associated with the client whose name is displayed in client name field 1902, including address information from address input screen 1800 in address table 1920, communication information from communication input screen 1830 in communication table 1930, and funding account information from funding account input screen 1860 in funding account table 1940. Each of address table 1920, communication table 1930, and funding account table 1940 has an add button 1950 and an edit button 1960 associated therewith for adding or editing information therein. Contact information table 1910 from contact information screen 1700 can similarly be edited with an associated edit button 1912. A button 1970 allows the client to add another client to the account. Clicking the “Go to Loans Step” button 1980 brings the client to the add loan screen 2100 shown in FIG. 20.

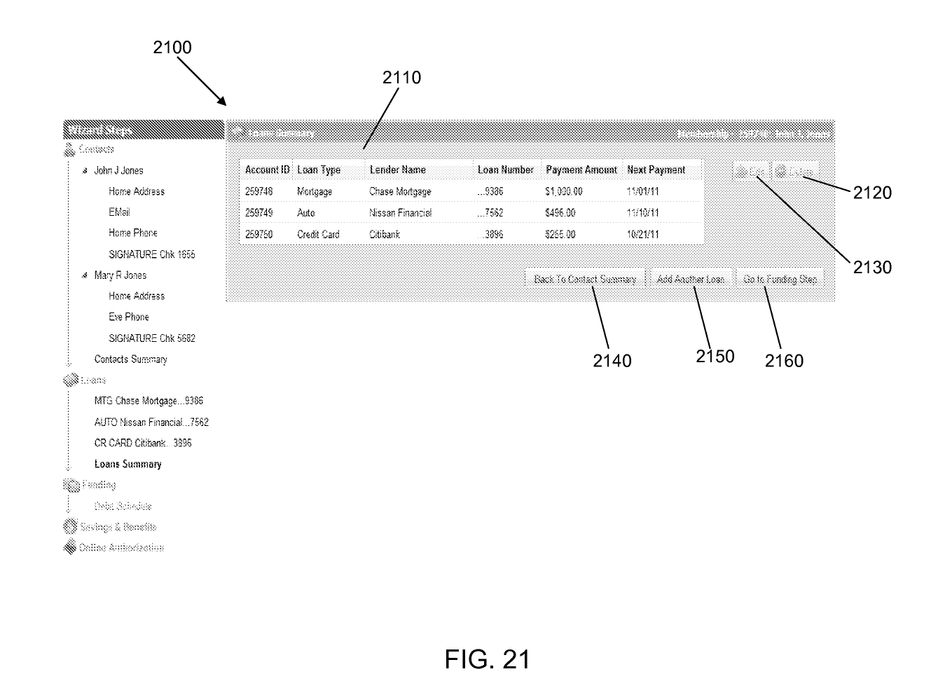

As shown in FIG. 20, information about a payment account, illustrated in the present example as a loan, may be added in add loan screen 2000. Add loan screen 2000 includes loan information fields 2010, lender information fields 2020, property information fields 2030, and loan contacts fields 2040. Contacts associated with the loan are displayed in loan contacts field 2050. Additional contacts can be added using add contacts button 2054. Clicking on next button 2060 brings the client to a loan summary screen 2100 shown in FIG. 21.

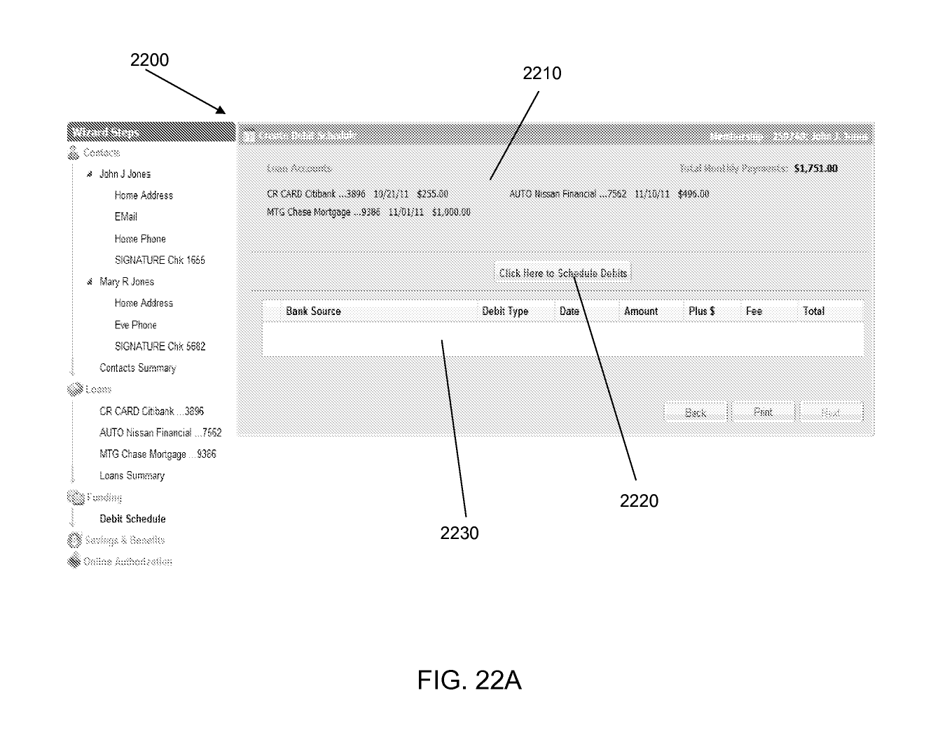

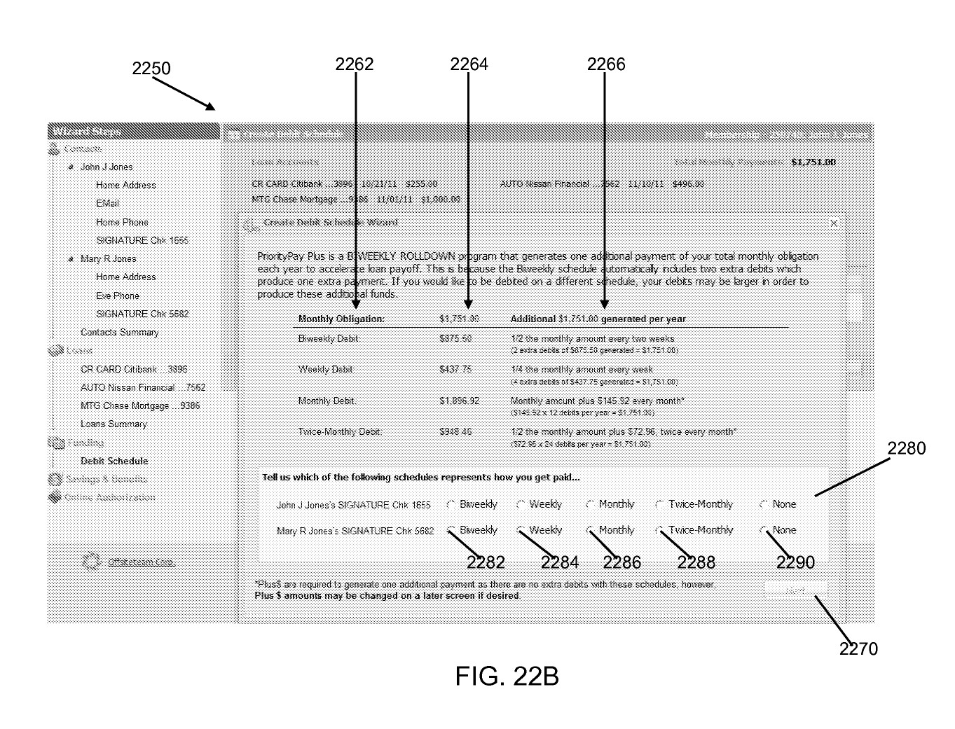

As shown in FIG. 21, each loan added in add loan screen 2000 is added to a loan summary table 2110. Clients can edit or delete a loan with edit button 2130 and delete button 2120, respectively. A loan can be added by clicking add loan button 2150. Contacts summary screen 1900 can be revisited by clicking contacts summary button 2140. Clicking a funding step button 2160 brings the client to a create debit schedule screen 2200 shown in FIG. 22A.

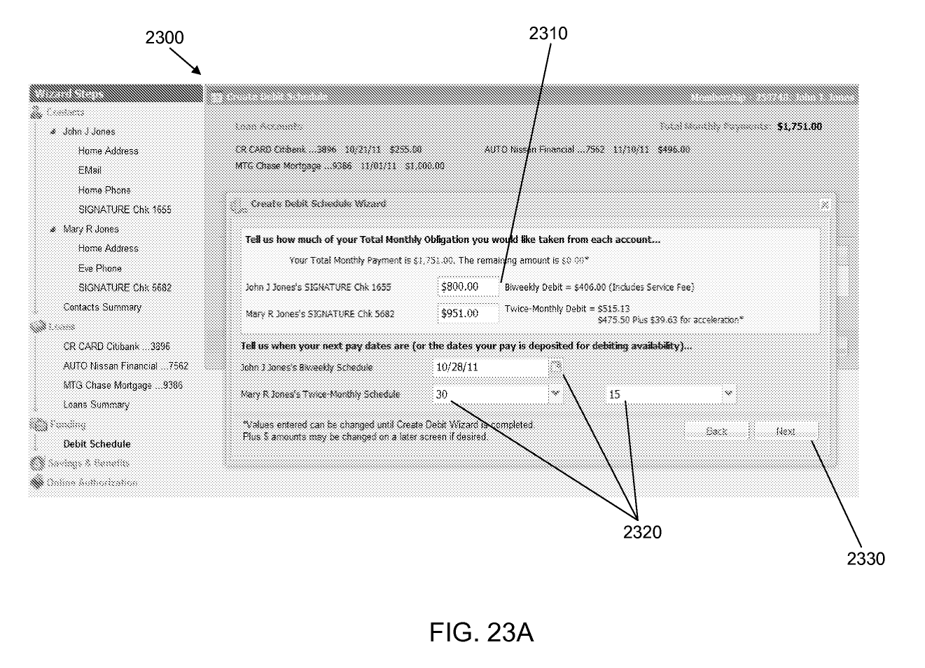

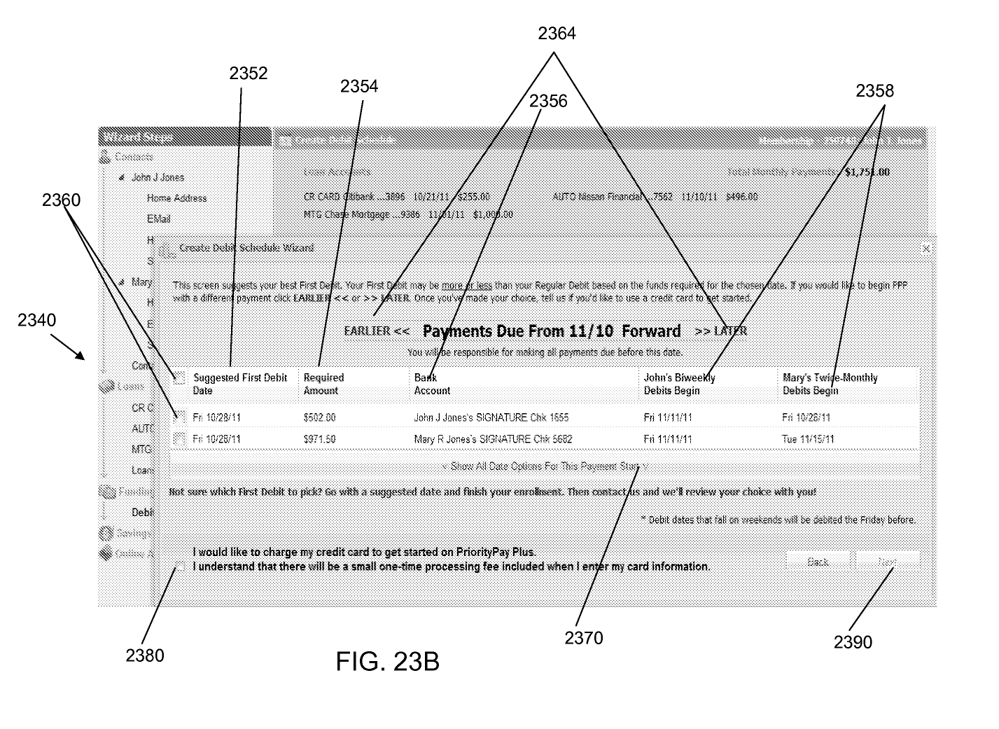

As shown in FIG. 22A, create debit schedule screen 2200 displays a loan summary 2210 having information from loan summary table 2110. Create debit schedule screen 2200 further has a debit schedule table 2230 that is empty before a debit schedule is created. Clicking debit schedule button 2220 opens a schedule wizard 2250, as shown in FIG. 22B. Schedule wizard 2250 prompts the client to select how often funds should be debited from the respective funding accounts (e.g., a client's bank account) listed in funding input screen 1860. Options 2280 are presented for scheduling debits biweekly 2282, weekly 2284, monthly 2286, twice-monthly 2288, and, in the case of multiple clients, none 2290. Schedule wizard 2250 shows the client the definitions 2266 and debit amounts 2264 for each periodic debit type 2262. Clicking next button 2270 brings the client to a debit selection screen 2300 of the schedule wizard 2250 shown in FIG. 23A.

As shown in FIG. 23A, funding input boxes 2310 allow the client to select how much of the total monthly payment should be debited from each funding account. Depending on the options 2280 selected, debit selection screen 2300 allows the client to select corresponding debit days 2320 for each funding account. For example, if the option for a funding account is twice-monthly 2288, the client may choose two days of the month for debiting from the funding account. An option selection of monthly 2286 from another funding account allows the client to choose one day of the month for debiting from that funding account. An option selection of weekly 2284 or biweekly 2282 further allows the client to choose a day of the week for debiting from the corresponding funding account. The client can select different scheduling information to be applied to each funding account, including the amount to be debited, the debit schedule type (e.g., biweekly, weekly, monthly, twice-monthly), the day of the month or week to execute the debit, etc. Clicking next button 2330 brings the client to a suggested first debit screen 2340 of the schedule wizard 2250 shown in FIG. 23B.

As shown in FIG. 23B, the suggested first debit screen 2340 allows the client to view suggested dates for making a first debit that begins the debit schedule, without using a grace period. Funding accounts 2356 indicate funding accounts designated for paying off the loan. In the present example two different funding accounts are designated. Each of the designated funding accounts is associated with a different client who is associated with the loan. Suggested first debit dates 2352 indicate suggested first dates for making a first debit. In the present example, the suggested first debit dates 2352 are the latest possible dates without using the grace period.

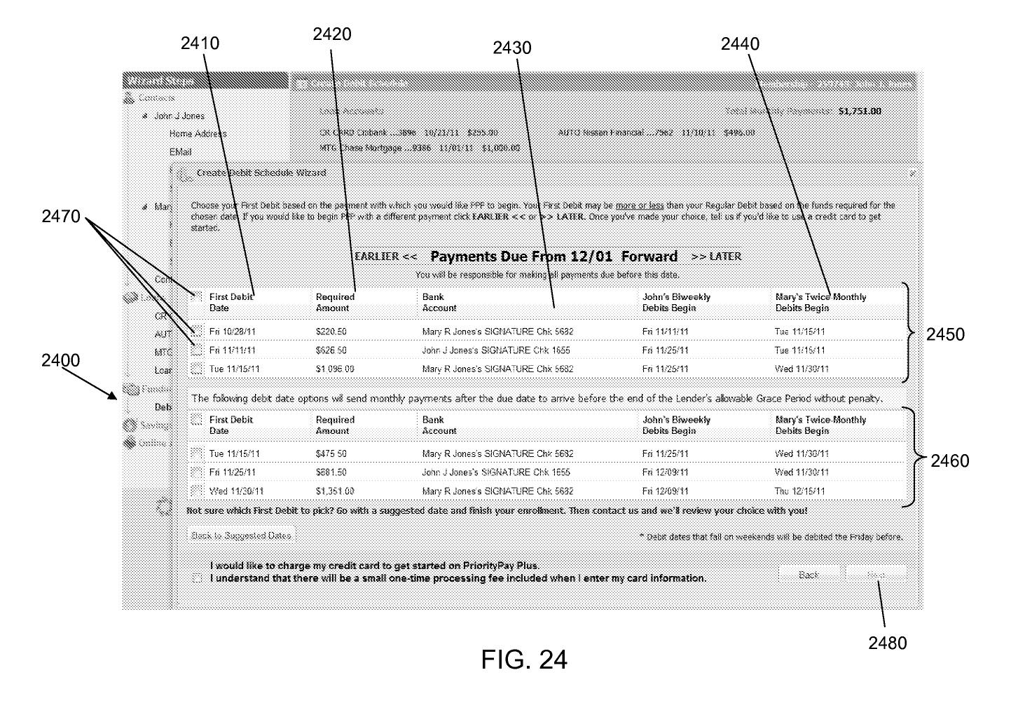

Required amounts 2354 indicate the required funding amount to be debited on the suggested first debit date 2352 for each of the associated funding accounts. Following debit dates 2358 indicates for each client the next date after the first debit date 2352 on which regular debits will be debited from the respective funding accounts in accordance with the debit schedule. Earlier/Later buttons 2364 allow the client to change the suggested first debit date 2352 to an earlier or later date for a selected funding account. The suggested first debit screen 2340 will then display updated amounts and dates for the required amounts 2354 and the following debit dates 2358 that adjust for the revised first debit date 2352 as displayed in screen 2400. The client may select any of the first debit dates 2352 using selection boxes 2360. Show options button 2370 allows the client to view all date options for a selected first debit date 2352 including those available when using the grace period. Button 2380 allows the client the option of using a credit card, which will include a processing fee, for a number of debits as indicated on a later screen 2630. FIG. 24 demonstrates date choices offered when clicking the Later button 2364. Screen 2400 includes a regular start table 2450 and a grace period start table 2460. Each of regular start table 2450 and grace period start table 2460 has first debit dates 2410, required amounts 2420, funding accounts 2430, following debit dates 2440, and selection boxes 2470. First debit dates 2410 indicate when funds will first be debited from a funding account.

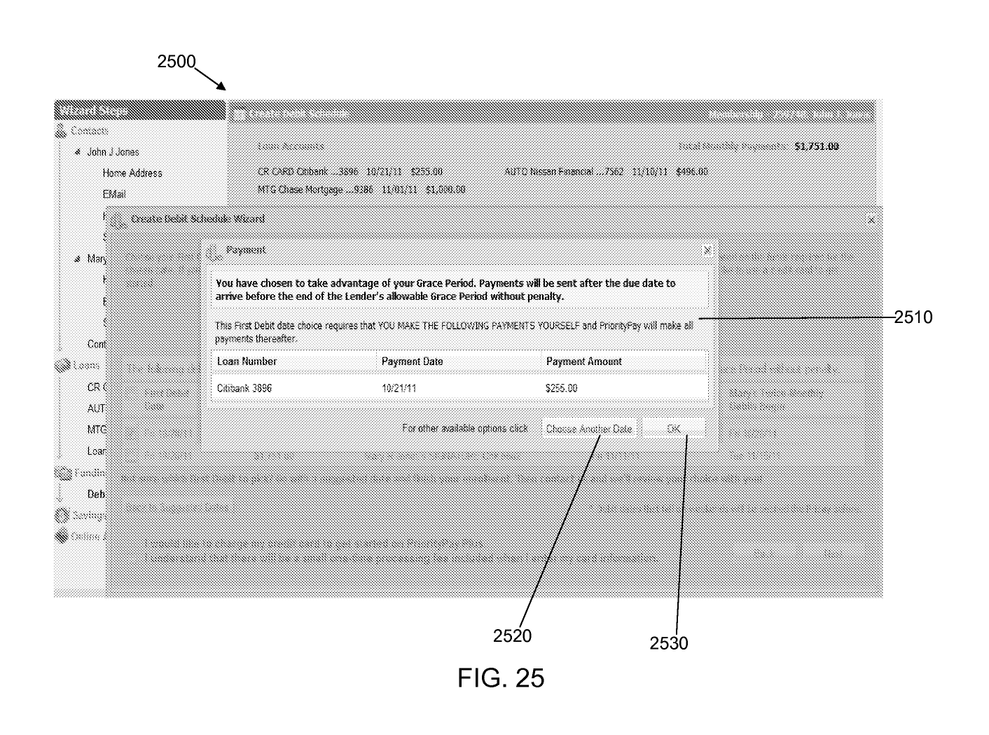

Following debit dates 2440 indicate when funds will first be debited from a funding account following the first debit. First debit dates 2410 in regular start table 2450 do not use any grace days, whereas first debit dates 2410 in grace period start table 2460 do take advantage of grace days. The client may select any of the first debit dates 2410 to activate the selected scheduled debits by selecting a selection box 2470. After selecting a selection box 2470 and clicking on next button 2480, a payment reminder window 2500 shown in FIG. 25 appears.

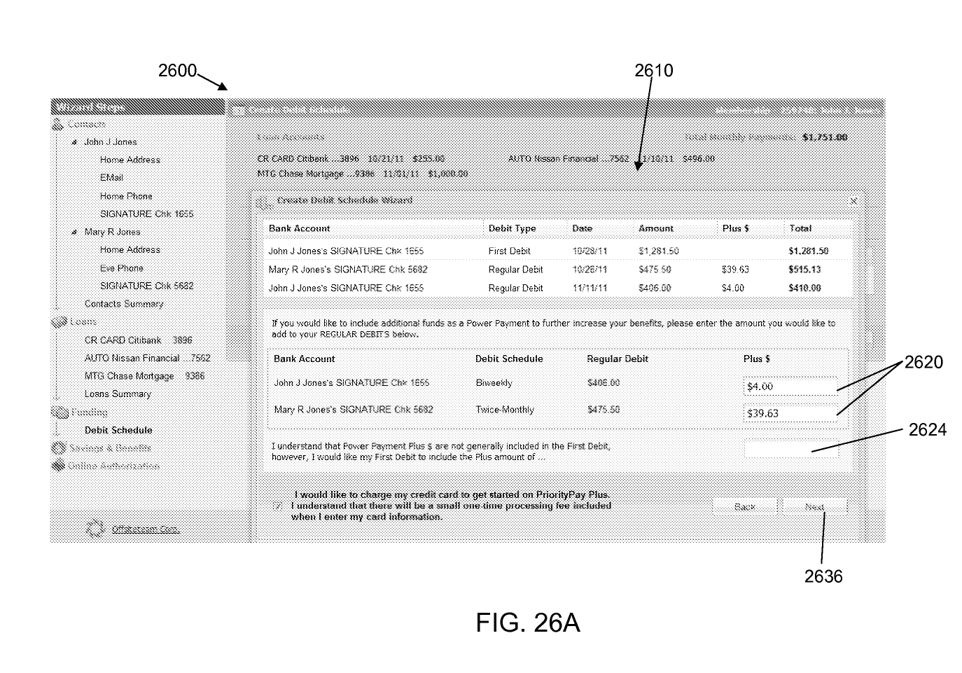

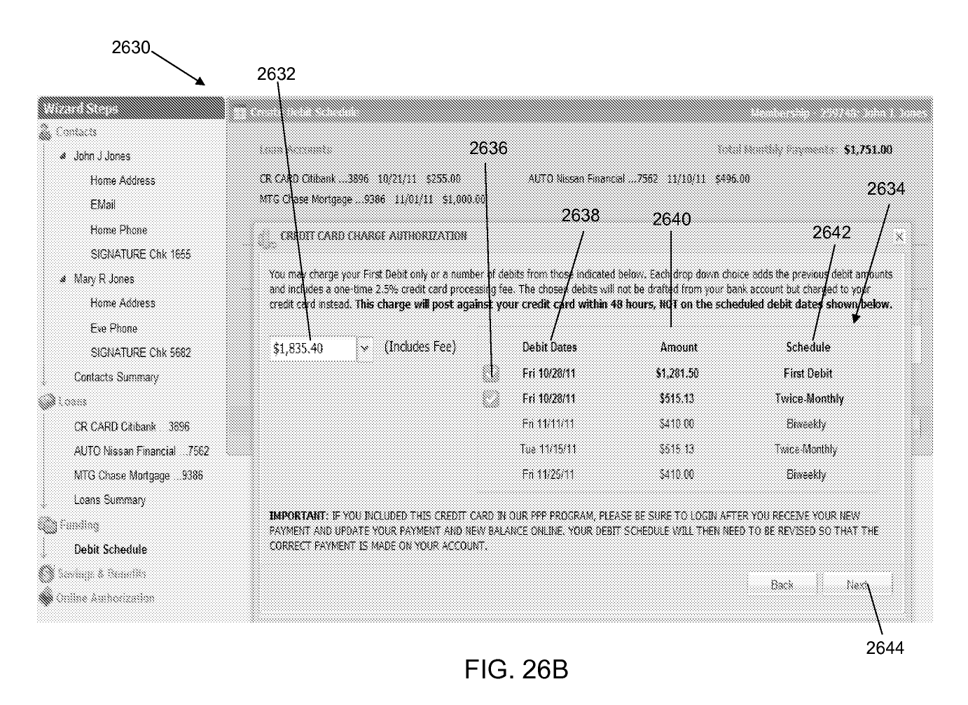

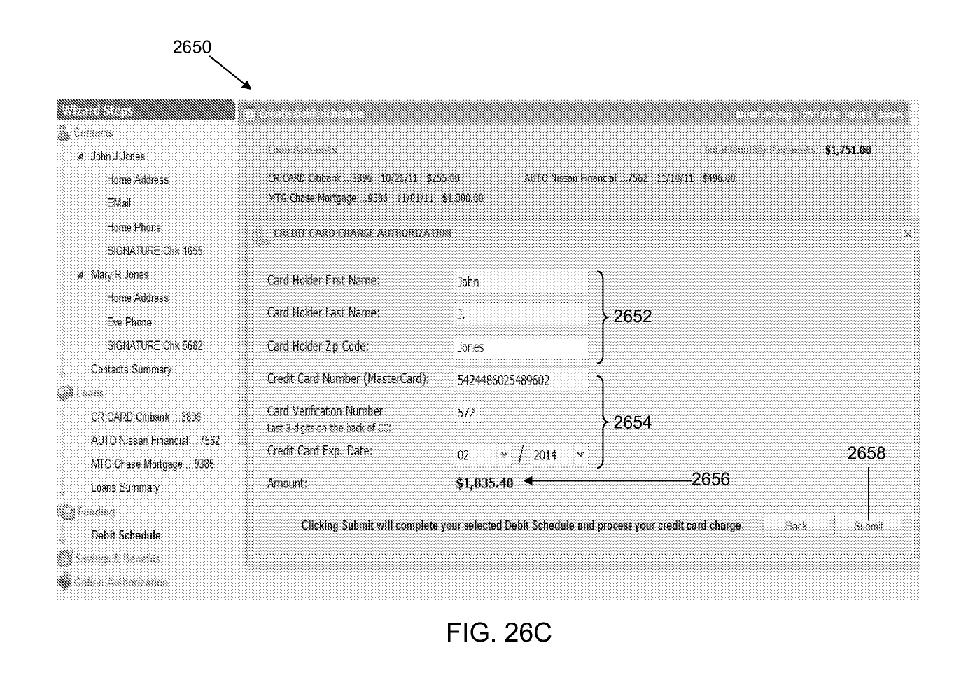

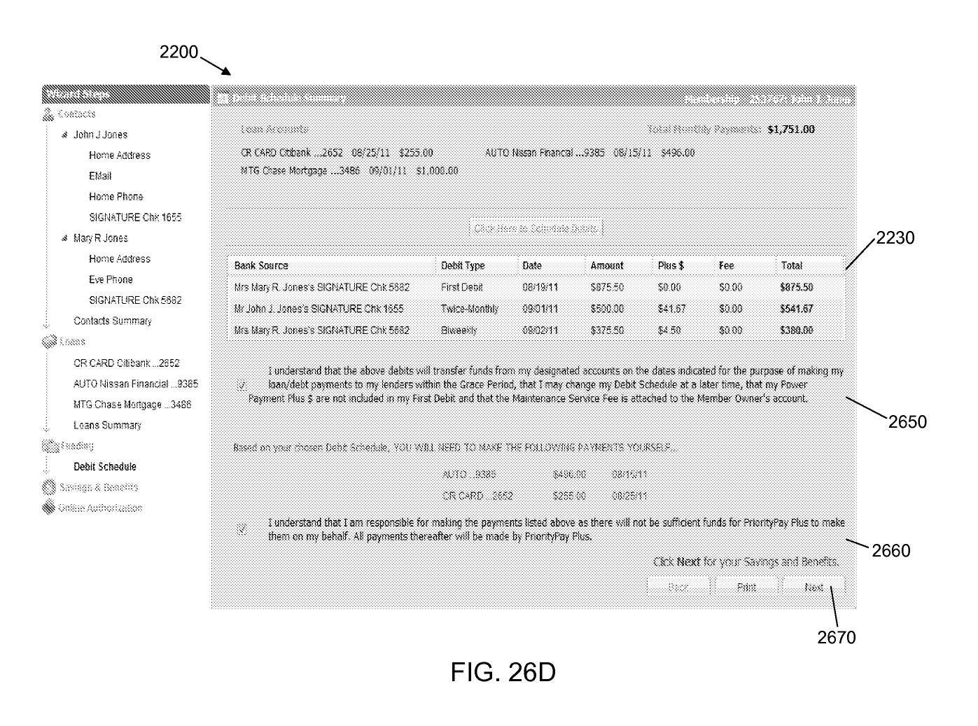

As shown in FIG. 25, payment reminder window 2500 displays a reminder message 2510 to remind the client of the final payments that the client must make himself before payments are made through the payment system 100. If the client wishes to change the selected first debit date 2410, the client clicks a choose button 2520 to return to selection screen 2400. If the client does not agree to change the selected first debit date 2410, the client clicks the OK button 2530 to go to an additional funding screen 2600 shown in FIG. 26A.

As shown in FIG. 26A, power plus funding screen 2600 displays a schedule summary 2610 summarizing selections made in the schedule wizard 2250. Power plus funding screen 2600 further includes power plus funding boxes 2620 allowing the client to add an optional additional debit amount (referred to as a “Power Payment” in debit screen 2600) to be debited from each funding account in addition to the periodic debits previously scheduled. There is also a first debit option 2624 for adding an additional debit amount to the first debit only.

Screens may be provided that allow the client to add, modify (e.g., increase or decrease), or remove power plus funding for an existing funding schedule at any time.

In embodiments, a client may be forced to participate in power plus funding if the client has a funding schedule that does not produce sufficient available funds for paying down principal and paying a fee to the service provider.

Additionally, screens may be provided that allow the client to create a series of schedules for regularly scheduled debits that are associated with respective selected time intervals. For example, a client may plan a different schedule to take effect during an extended vacation, maternity leave, or upon retirement.

Clicking next button 2636 ends schedule wizard 2250 and when the credit card option is elected, brings the client to credit card authorization screen 2630 shown in FIG. 26B.

As shown in FIG. 26B, credit card authorization screen 2630 displays a list of debits 2634 that the client can authorize to be paid by charging a credit card. A selection drop down box 2632 provides the total amount required, with credit card usage fees, based on the number of debits the client chooses to include. The debit selection box 2634 displays the debit date 2638, the amount 2640 associated with the debit, and the schedule 2642 with which it is associated. The amount chosen from the drop down box 2632 automatically inserts check marks 2636 illustrating the debits that will be included in the charge transaction. Clicking on next button 2644 brings the client to an additional credit authorization screen 2650 shown in FIG. 26C.

As shown in FIG. 26C, credit authorization screen 2650 displays entry fields for card holder information 2652, information about the credit card 2654, and the amount to be charged 2656. By clicking on the submit button 2658, the client authorizes payment, ends schedule wizard 2250, and returns to debit schedule screen 2200, which is updated accordingly as shown in FIG. 26D.

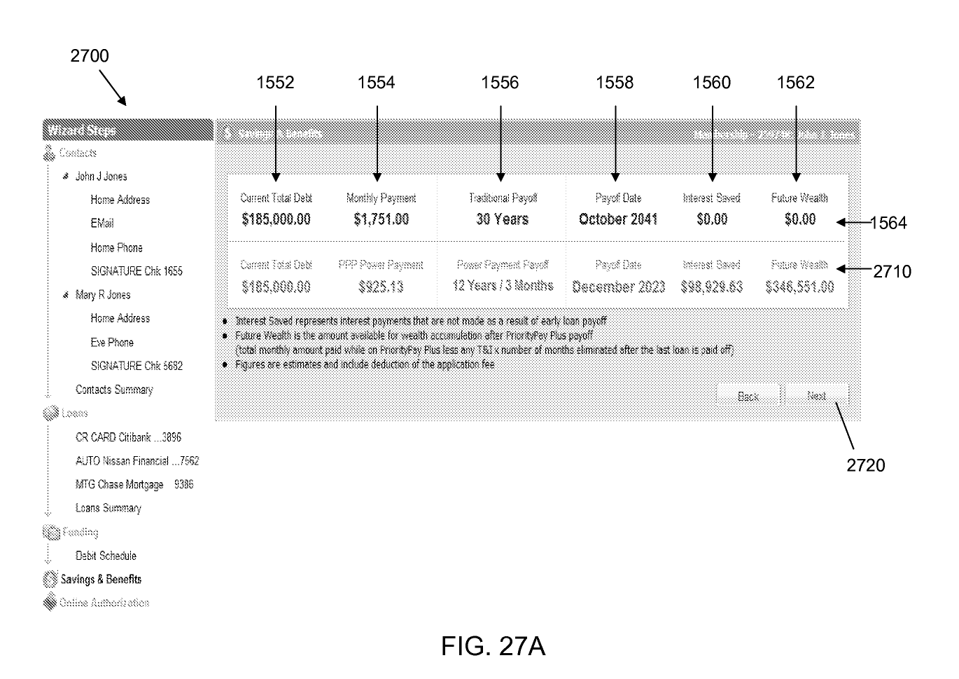

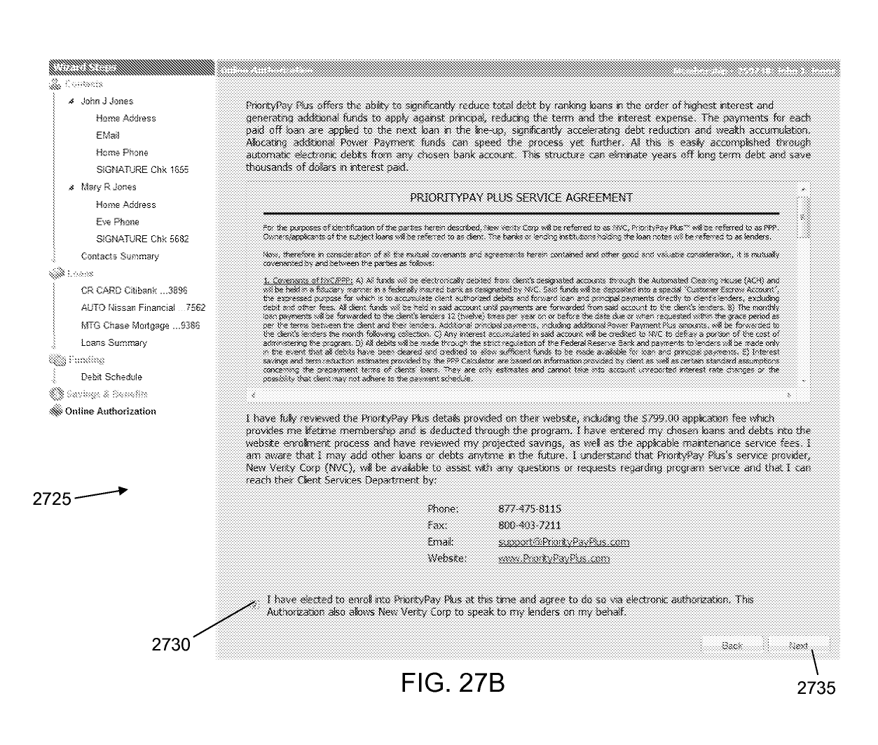

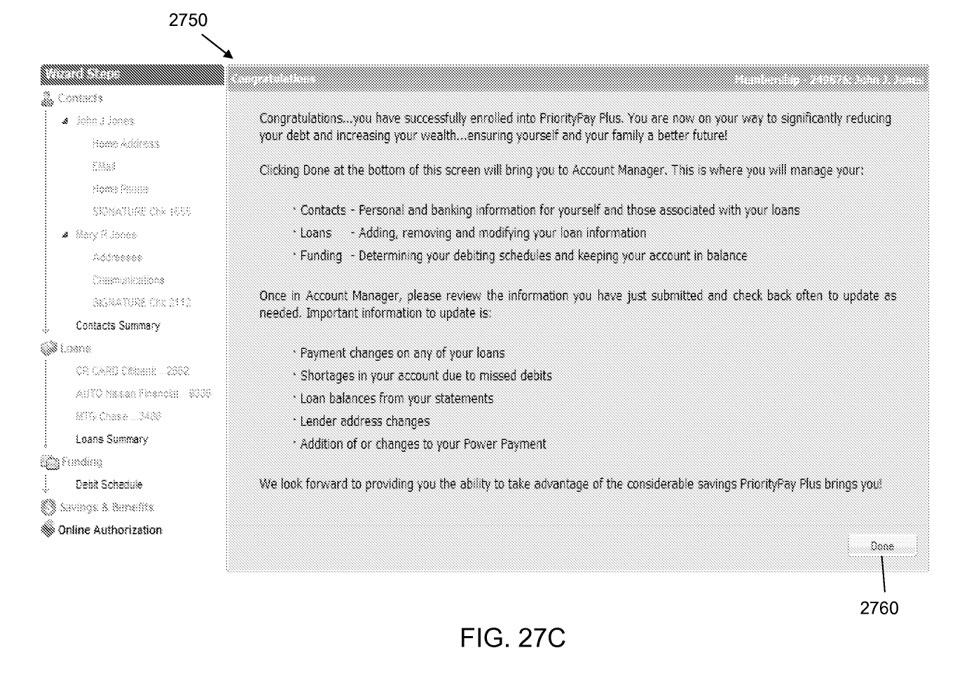

As shown in FIG. 26D, debit schedule table 2230 now contains debit information entered via schedule wizard 2250. When boxes associated with agreements 2650 and 2660 are checked by the client, the client may click next button 2670 to view a savings & benefits projection screen 2700 shown in FIG. 27A.

As shown in FIG. 27A, savings & benefits projection screen 2700 is substantially similar to projections table 1550. Savings & benefits projection screen 2700 includes a current debt column 1552, a payments column 1554, a payoff length column 1556, a payoff date column 1558, an interest saved column 1560, and a future wealth column 1562. Savings & benefits projection screen 2700 further includes a traditional payoff row 1564 and a customized power funding/payment row 2710. Customized power funding/payment row 2710 is calculated based on debit schedule table 2230. Clicking on the next button 2720 brings the client to the authorization screen 2725, as shown in FIG. 27B, which allows the client to review a service agreement, to elect to enroll in the payment program, and to authorize the service provider to act on behalf of the client. Clicking on the check box 2730, which indicates that the client elects to enroll in the payment program and authorizes the service provider to act on the client's behalf, and then clicking on the next button 2735 takes the client to a completed enrollment screen 2750, which is shown in FIG. 27C. As shown in FIG. 27C, completed enrollment screen 2750 includes a done button 2760, which the client may click to complete and exit the enrollment process.

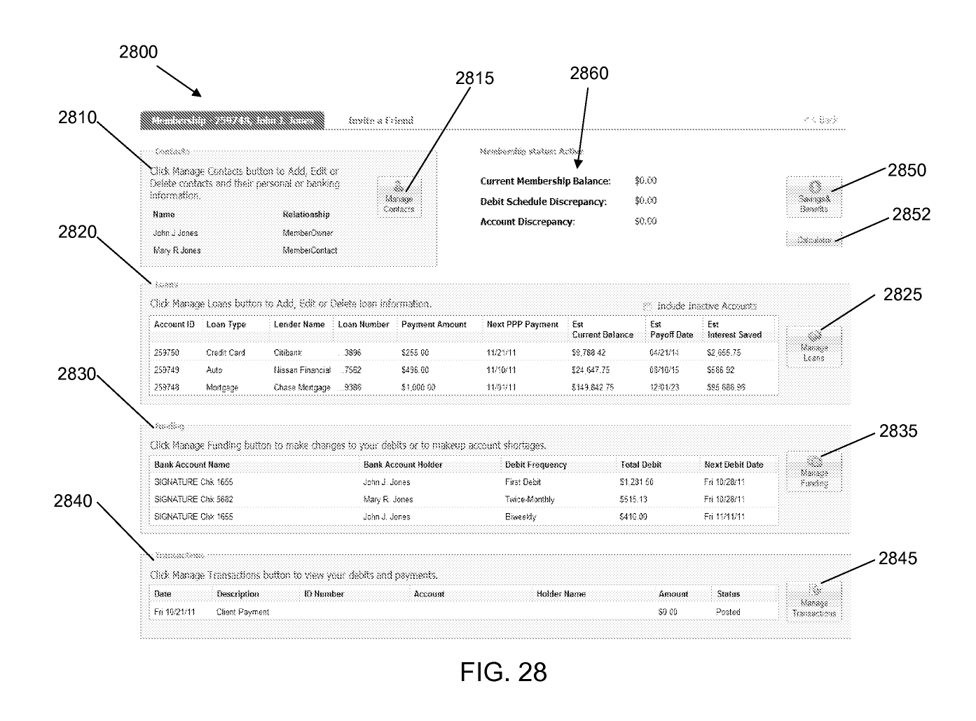

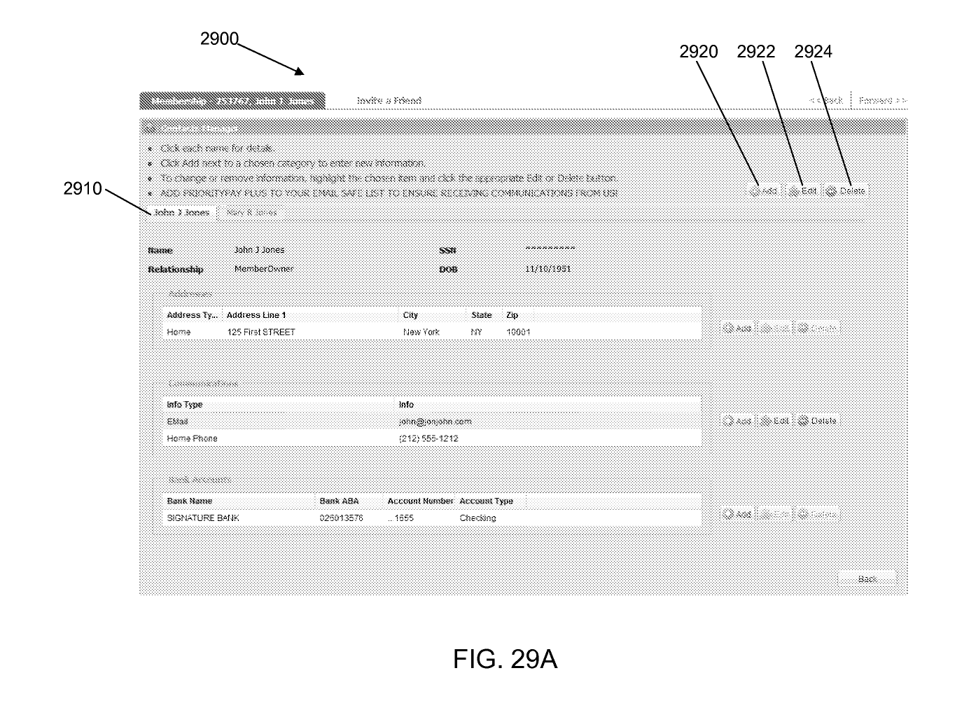

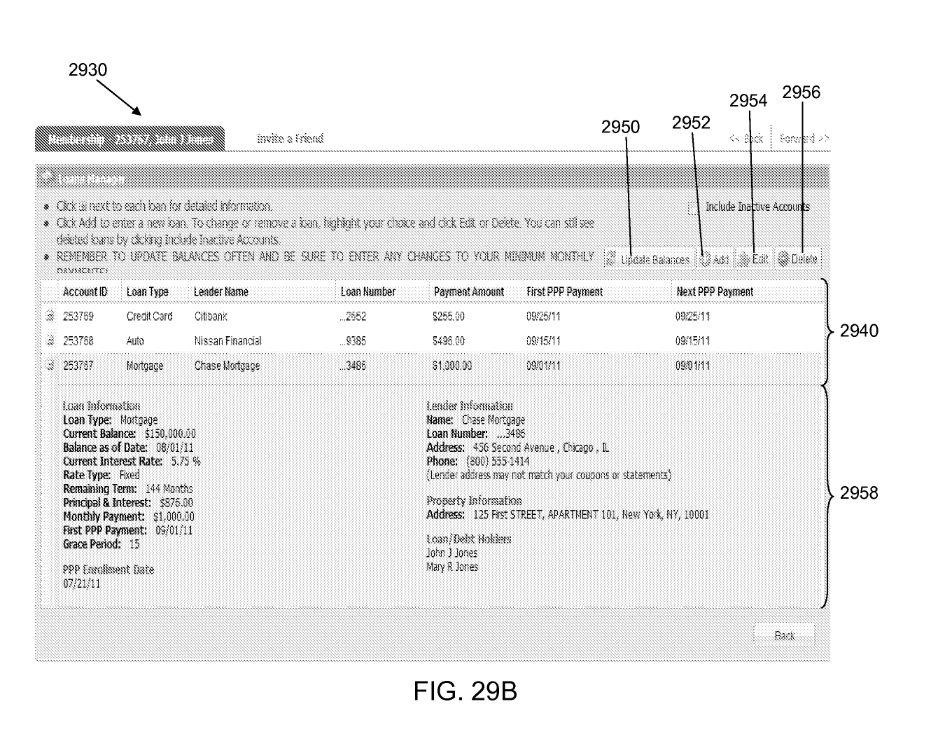

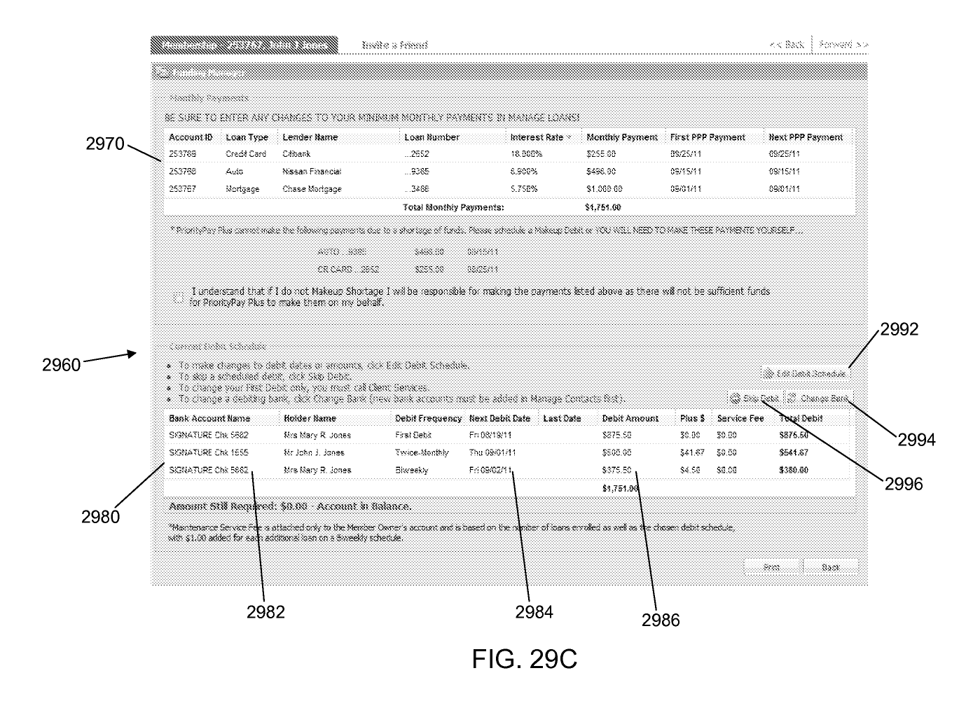

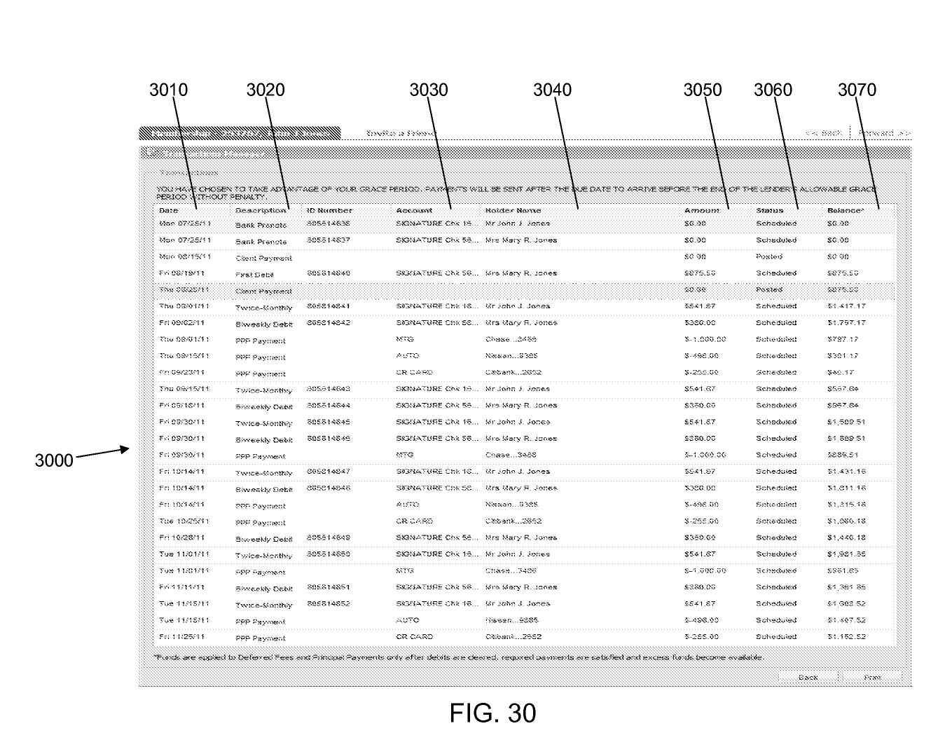

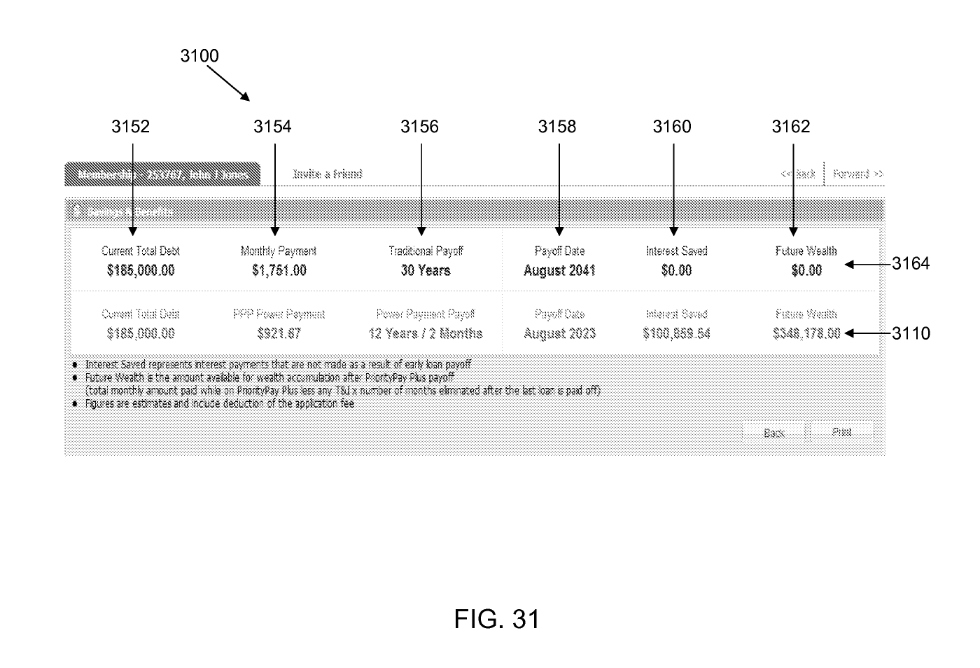

As shown in FIG. 28, once a client is enrolled, the client may manage a created member account through an account home page 2800. Account home page 2800 is accessed by clicking login link 1440 and entering login information, e.g., that matches information entered in login fields 1730. Account home page 2800 includes a contacts manager 2810 having a manage contacts button 2815, a loans manager 2820 including a manage loans button 2825, a funding manager 2830 having a manage funding button 2835, a transactions manager 2840 having a manage transactions button 2845, a savings and benefits button 2850, and a balance indicator 2860. Alternatively, the loans manager 2820 may be replaced with a more general account manager for managing other accounts, such as other debt types and expenses. The account manager may include a manage accounts button instead of the manage loans button 2825. Balance indicator 2860 indicates whether any balance discrepancy, including a debit schedule discrepancy or account discrepancy, exists in the member account. Clicking on manage contacts button 2815 opens a contacts manager 2900 shown in FIG. 29A. Clicking on manage loans button 2825 opens a loans manager 2930 shown in FIG. 29B. Clicking on manage funding button 2835 opens a funding manager 2960 shown in FIG. 29C. Clicking on manage transactions button 2845 opens a transactions manager 3000 shown in FIG. 30. Clicking on savings & benefits button 2850 opens a savings and benefits page 3100 shown in FIG. 31. Clicking on the Calculator button 2852 opens a screen that populates the client's current loans and debts and allows the client to make changes such as add loans or change power payments to see what the results will be before actually making the changes.

As shown in FIG. 29A, contacts manager 2900 is similar to contacts summary screen 1900. Contacts manager 2900 includes tabs 2910 for viewing contact information for each client enrolled in the member account. The contact information can be edited by clicking add buttons 2920, edit buttons 2922, and delete buttons 2924.

As shown in FIG. 29B, loans manager 2930 includes a loans table 2940 displaying all loan accounts. Alternatively, the loans manager 2930 may be replaced with a more general account manager that includes an accounts table 2940 displaying all accounts. The accounts may include accounts for other types of debt and expenses. Balances of the loan accounts can be updated by clicking update balances button 2950. The loan accounts can be added, edited, or deleted with add button 2952, edit button 2954, and delete button 2956, respectively. Loan information area 2958 displays information related to a loan selected from the loans listed in the loans table 2940. A loan account may be selected, for example, by highlighting it.

As shown in FIG. 29C, funding manager 2960 includes a payment accounts table 2970 similar to loans table 2940. Funding manager 2960 further includes a funding accounts table 2980 including funding accounts 2982, next debit dates 2984, and next debit amounts 2986. The client can change a debit schedule by clicking edit debit schedule button 2992. The client can skip a debit by clicking skip debit button 2996. The client can change funding account information by clicking change bank button 2994.

As shown in FIG. 30, transactions manager 3000 allows the client to view transactions information including transaction dates 3010, transaction descriptions 3020, transaction accounts 3030, transaction account holders 3040, transaction amounts 3050, transaction statuses 3060, and balances 3070.

As shown in FIG. 31, savings & benefits page 3100 is similar to savings & benefits projection screen 2700 of FIG. 27A with values in customized power funding/payment row 3110 updated to reflect transactions that have occurred since enrollment. As shown in FIG. 31, the process server 220 calculates projected savings and benefits resulting from monthly payments 3154 associated with the power funding/payment displayed in the power funding/payment row 3110. The projected savings and benefits for the monthly payment 3154 ($921.67 per month) are displayed in the power funding/payment row 3110, including the payoff date 3158 (August 2023), interest saved 3160 ($100,859.54), and future wealth 3162 ($348,178.00). These savings and benefits can be compared with the payoff date 3158 (August 2041), interest saved 3160 ($0.00), and future wealth 3162 ($0.00) displayed in the traditional payoff row 3164.

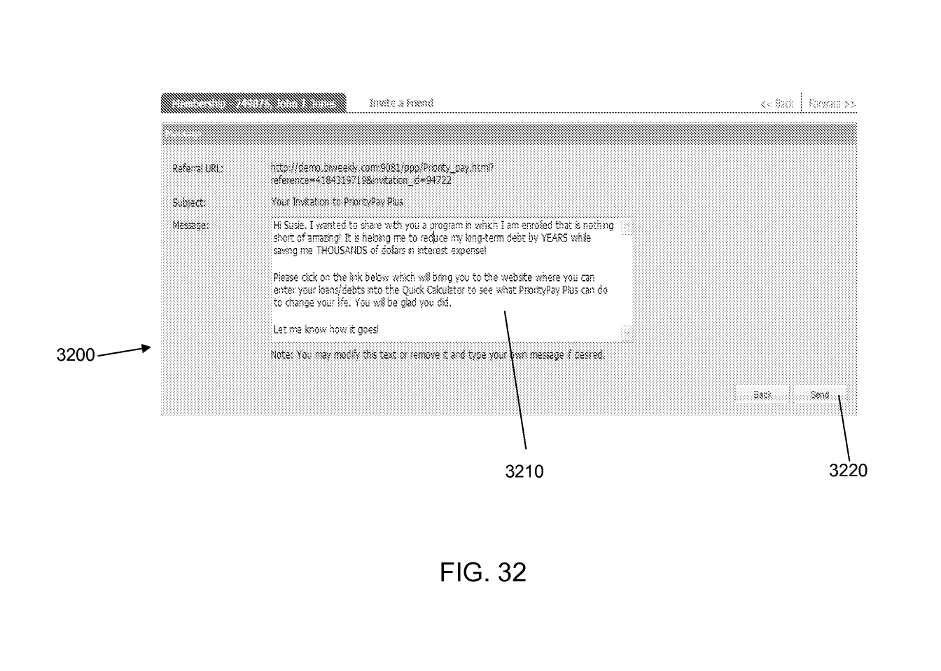

As shown in FIG. 32, a referral screen 3200 allows a client to invite a friend to enroll in the payment system 100. The client may type a custom message into a message box 3210 or use a default message. The client clicks a send button 3220 to send the message. The client will earn a credit in their account for each referral enrolled.

In addition to the screens shown in FIGS. 14-32, screens may be provided which allow the client to adjust scheduled debits. For example, first debits, regular debits, and power plus funding may be adjusted.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A method of operating an electronic payment system, the method as executed by a processor comprising:
generating funding source information based upon at least one funding source;
generating a funding profile based upon the funding source information and client information;
generating funding schedule information based upon at least one funding schedule based upon the at least one funding source, the funding schedule information comprising a funding schedule type;
generating recurring payment account information based upon a plurality of recurring payment accounts;
allocating, an available funding amount from the at least one funding source to the plurality of recurring payment accounts based upon the funding source information, the funding schedule information, and the recurring payment account information;
wherein allocating an available funding amount from the at least one funding source comprises:
projecting a plurality of recurring funding amounts from the at least one funding source over a predetermined time window based upon the funding profile;
projecting a plurality of recurring payments to at least one payment account of the plurality of payment accounts over the predetermined time window based upon a payment profile;
comparing the projected plurality of funding amounts and the projected plurality of payments to obtain projected balances;
determining at least one minimum projected balance over the predetermined time window based upon the projected balances; and
determining an excess funding amount or a payment shortage amount based upon the at least one minimum projected balance.
refunding the excess funding amount to the at least one funding source on or after the minimum projected balance date if it is determined that there is an excess funding amount; and
scheduling at least one makeup funding event if it is determined that there is a payment shortage amount.

2. The method of claim 1, wherein allocating the funding amount from the at least one funding source to the plurality of recurring payment accounts comprises:
determining a funding event of a funding schedule of the at least one funding schedule, the funding event comprising the funding amount;
dividing the funding amount into a plurality of funding shares; and
allocating the plurality of funding shares to the plurality of recurring payment accounts.

3. The method of claim 1, further comprising prompting a client to select the funding schedule type, wherein the funding schedule type is selected from the group consisting of weekly, biweekly, twice-monthly, and monthly.

4. The method of claim 1, further comprising:
determining an effective payment send date for each payment account of the plurality of payment accounts based upon payment information comprising a payment due date, payment delivery days, and payment safety days;
allocating the available funding amount to the plurality of payment accounts in the order of the effective payment send dates; and
determining the available funding amount based upon a funding availability period.

5. The method of claim 4, wherein the payment information further comprises a business day adjustment.

6. The method of claim 4, wherein the payment due date for at least one of the plurality of payment accounts is a payment grace due date.

7. The method of claim 4, further comprising determining the funding availability period based upon the type of the funding source.

8. The method of claim 1, further comprising determining a minimum projected balance date within the predetermined time window on which the at least one minimum projected balance occurs.

9. The method of claim 8, further comprising allocating the excess funding amount to the at least one payment account on or after the minimum projected balance date if it is determined that there is an excess funding amount.

10. The method of claim 1, wherein determining an excess funding amount or a payment shortage amount comprises:
determining the sign of the minimum projected balance;
determining an excess funding amount if the sign of the minimum projected balance is positive; and
determining a payment shortage amount if the sign of the minimum projected balance is negative.

11. The method of claim 1, further comprising:
determining whether a first recurring payment account of the plurality of payment accounts is paid off; and
allocating any portion of a regular funding amount that was intended for the first recurring payment account to a second recurring payment account of the plurality of payment accounts if it is determined that the first recurring payment account is paid off, the second recurring payment account having the highest priority level excluding the first recurring payment account,
wherein the priority level is determined based upon interest rate, account balance, periodic payment amount, or term of a recurring payment account.

12. The method of claim 1, further comprising:
prompting a client to input an additional funding amount;
receiving additional funding information comprising the additional funding amount; and
allocating the additional funding amount to a payment account of the plurality of payment accounts having the highest priority information.

13. The method of claim 1, further comprising re-allocating funding amounts in response to a re-allocation event, wherein the re-allocation event is selected from the group consisting of a membership event, a new account change, and an active account event,
wherein the membership event is selected from the group consisting of a funding schedule change, a returned funding amount, and a skipped funding amount,
wherein the new account change is selected from the group consisting of a first payment date, a payment account due date, and a payment account grace period, and
wherein the active account event is selected from the group consisting of a payment change, a direct client payment, and a termination.

14. The method of claim 1, further comprising:
receiving updated client information relating to at least one client, the updated client information selected from the group consisting of funding source information relating to at least one funding source, payment account information relating to at least one payment account, a regular funding cycle for the at least one funding source, and a regular funding amount for the at least one funding source; and
updating at least one funding schedule based upon the updated client information.
